(19) United States
(12) Patent Application Publication
(10) Pub. No.: US 2007/0288254 A1
(43) Pub. Date: Dec. 13, 2007

(54) SYSTEM AND METHOD FOR EXCHANGING TRANSACTION INFORMATION USING IMAGES

(75) Inventor: Mark Eisner, Boxborough, MA (US)

Correspondence Address: FOLEY AND LARDNER LLP;SUITE 500, 3000 K STREET NW, WASHINGTON, DC, 20007, US

(73) Assignee: FireStar Software, Inc.

(21) Appl. No.: 11/745,146

(22) Filed: May 7, 2007

Related U.S. Application Data
(60) Provisional application No. 60/798,315, filed on May 8, 2006.

(51) Int. Cl. G06Q 10/00; G06F 15/02; G06Q 30/00; G06F 9/46

(52) U.S. Cl. 705/1; 705/9

(57) ABSTRACT

A system for communicating transaction information includes a plurality of client application devices and a plurality of transaction exchangers. A transaction processor is configured as a facsimile processor that is configured for processing a received facsimile image, by processing the received facsimile image to identify text data in the facsimile image, converting the identified text data to a standardized format, validating the identified text data in the standardized format, mapping the text data in the standardized format to data in a specified format; and providing the data in the specified format for further processing.

### BACKGROUND

1. Field of the Invention

The present invention relates to communication systems. More particularly, the present invention relates to a system and method for exchanging transaction information among remote transaction exchange applications for participating in, facilitating and/or completing transactions.

2. Background Information

With the continued growth and expansion of computer technology and computer networks, such as the Internet, many companies are attempting to capitalize on the ability to perform automated electronic transactions with other companies as part of their daily and on-going businesses processes and business management. A computerized business transaction is a domain specific, distributed application that involves the sending and receiving of information that is part of a multiple-enterprise business process. The information exchanges in a business transaction are contained in standardized and self-defined messages. Software applications in an enterprise create and process messages in preparation for sending them and process the messages after they have been received. In some cases, it can appear that human beings do the processing, such as ordering a widget online, and the like. However, since those individuals must interact through an application, say, for example, a browser, it is considered that an “application” is doing the processing.

Business transactions can be as simple as the one-way transmission of information, for example, a payment from an accounts payable application in Corporation A to an accounts receivable application in Corporation B. The business transactions can be as complicated as a multi-step transaction that involves many players and include many sub-transactions, for example, the cross-border settlement of a stock purchase that could involve over a dozen players. Also, business transactions can span a very short time interval, for example, a request/response interaction that approves the use of a credit card, or can literally span days or months, for example, the settlement of an insurance claim.

However, companies face numerous challenges to automating multi-enterprise electronic transactions. Generally, each company will have a private computer network and use a proprietary data format for conducting various types of transactions. Consequently, there is no common data format that would allow each of these companies to easily share information for automatically conducting such electronic transactions. Accordingly, disparate client information technology environments can generate excessive custom integration costs. Additionally, it can be exceedingly difficult to enforce a consistent transaction process across multiple independent companies, particularly when each company uses a different transaction process and different data formats for a given transaction. The high cost of integration can limit market penetration of such solutions. If transaction messages passed between companies are not valid, there can be a significant loss in time and money, and a concomitant increase in liability, for these companies to diagnose and repair the invalid transaction messages. As a result, modifying the management and transaction systems of companies to support multi-enterprise electronic transaction can be extremely costly and difficult to implement. Such problems and difficulties increase quickly as the client population grows to large numbers.

Therefore, there is a need for a system that greatly simplifies the development process for building inter-corporate automated transaction exchanges. Such a system would minimize changes to each client's environment and would operate with each company's data formats and existing products. Such a system would provide the capability to manage message creation, consistency, data validation, and security, and allow the ability to audit and non-repudiate the transactions. Such a system would also enable each client to maintain their proprietary environment independent of the transaction exchange application.

### SUMMARY OF THE INVENTION

A system and method are disclosed for exchanging transaction information among remote transaction exchange applications for participating in, facilitating and/or completing transactions. In accordance with exemplary embodiments, according to a first aspect of the present invention, a system for communicating transaction information includes a plurality of client application devices distributed among one or more local client application devices and one or more remote client application devices. The system includes a plurality of transaction exchangers distributed among one or more local transaction exchangers and one or more remote transaction exchangers. The one or more local transaction exchangers are configured to communicate the transaction information with the one or more local client application devices, with which the one or more local transaction exchangers are associated, using one or more local data formats. The one or more remote transaction exchangers are configured to communicate the transaction information with the one or more remote client application devices, with which the one or more remote transaction exchangers are associated, using one or more remote data formats. The one or more local transaction exchangers are configured to transform the transaction information in the one or more local data formats into one or more common data formats that are shared with the one or more remote transaction exchangers. The one or more remote transaction exchangers are configured to transform the transaction information in the one or more common data formats into the one or more remote data formats. The transaction information from the one or more local client application devices is communicated to the one or more remote client application devices for initiating, facilitating and/or completing a transaction.

According to the first aspect, the one or more remote transaction exchangers can be configured to transform transaction information in the one or more remote data formats into the one or more common data formats that are shared with the one or more local transaction exchangers. The one or more local transaction exchangers can be configured to transform the transaction information in the one or more common data formats into the one or more local data formats. The transaction information from the one or more remote client application devices can be communicated to the one or more local client application devices.

According to the first aspect, the transaction can comprise a compound transaction. The one or more local transaction exchangers and the one or more remote transaction exchangers can be configured to suspend the compound transaction until a predetermined condition is satisfied. The predetermined condition can comprise a time limit. Each of the one or more local transaction exchangers and the one or more remote transaction exchangers can be configured to determine a status of a component of the compound transaction. Each of the one or more local transaction exchangers and the one or more remote transaction exchangers can be configured to exchange a status of a component of the compound transaction. The transaction can be supported by the plurality of client application devices. The one or more common data formats can include information configured to allow the one or more remote client application devices to apprehend the transaction. The system can be configured to facilitate an initiation, participation in and a completion of the transaction automatically.

According to the first aspect, the transaction can be associated with at least one of a commercial transaction, a legal transaction, a financial transaction, a governmental transaction, a medical transaction, a civic transaction, and a social transaction. The transaction can be associated with at least one of a banking industry, a trading/securities/financial industry, a healthcare industry, a telecommunication industry, and a satellite service industry. The transaction can associated with at least one of an energy industry, a utility industry, a manufacturing industry, an automotive industry, and a pharmaceutical industry.

According to the first aspect, the plurality of transaction exchangers can be associated with a transaction administrator. The transaction administrator can be configured to administer each transaction exchanger. The transaction administrator can be configured to administer each transaction exchanger via automated messages. The plurality of transaction exchangers can comprise processing modules that can be configured to be updated using secure administrative messages. Configuration information of each transaction exchanger can be configured to be updated using the secure administrative messages. Transaction information passed between the plurality of transaction exchangers can include at least one of unique transaction ID tags, envelope ID tags, and message ID tags. An administrative message can be configured to query one or more transaction exchangers to ascertain a status of the transaction, based on the at least one of the unique transaction ID tags, envelope ID tags and message ID tags. Each transaction exchanger can include information configured to form a fully distributed data store in aggregate with information associated with other transaction exchangers. An administrative message can be configured to query the fully distributed data store. Information can be generated into a standardized format, such as, for example, HTML, XHTML, or XML document. Standardized documents, such as standardized XML documents, generated from information contained in two or more transaction exchangers can be combined into one standardized document that can be used for non-repudiation of a business transaction.

According to the first aspect, customized processes can be associated with one or more transactions. The customized processes can be distributed via administrative messages. The administrative messages can be configured to utilize message security and provide a definable block in an envelope. The definable block can be configured to provide parameters for the customized processes.

According to a second aspect of the present invention, a transaction exchanger includes an information queue module. The information queue module is configured to communicate transaction information in one or more local data formats with one or more local client applications. The transaction exchanger includes a formatter module in communication with the information queue module. The formatter module is configured to transform the transaction information in the one or more local data formats into a data format associated with the transaction exchanger. The transaction exchanger includes a mapping module in communication with the formatter module. The mapping module is configured to convert the transaction information in the data format associated with the transaction exchanger into a common data format that is shared with at least one other transaction exchanger, using a normative data model configured to generate normative transaction information. The transaction exchanger includes a message processing module in communication with the mapping module. The message processing module is configured to generate a transaction message by providing an envelope for the normative transaction information in the common data format. The transaction exchanger includes one or more communication modules in communication with the message processing module. The one or more communication modules are configured to communicate the transaction message with at least one other transaction exchanger for initiating, facilitating and/or completing a transaction.

According to the second aspect, the formatter module can be configured to transform the transaction information in a data format associated with the transaction exchanger into the one or more local data formats. The mapping module can be configured to convert the normative transaction information in the common data format into a data format associated with the transaction exchanger. The message processing module can be configured to process the envelope for the normative transaction information in the common data format. The message processing module can be configured to execute predetermined next actions and processing demands imposed by the at least one other transaction exchanger. The one or more communication modules can be configured to receive a transaction message provided by the at least one other transaction exchanger.

According to the second aspect, the transaction exchanger can include a first custom-processor module in communication between the information queue module and the formatter module. The first custom-processor module can be configured to process the transaction information using the one or more local data formats. The data format associated with the transaction exchanger can comprise, for example, XML or the like. The transaction exchanger can include a second custom-processor module in communication between the formatter module and the mapping module. The second custom-processor can be configured to process transformed transaction information using the data format associated with the transaction exchanger. The transaction exchanger can include a validation module in communication between the mapping module and the message processing module. The validation module can be configured to validate the normative transaction information. The validation module can be configured to validate the normative transaction information to ensure that the normative transaction information includes data required by mandatory data fields. The validation module can be configured to validate the normative transaction information to ensure that the normative transaction information includes data required by cross-data field constraints.

According to the second aspect, the transaction exchanger can include a data enrichment module in communication between the validation module and the message processing module. The data enrichment module can be configured to customize the validated normative transaction information to generate enriched normative transaction information. The one or more communication modules can be configured to record transmitted transaction messages and transaction states of the transmitted transaction messages. The one or more communication modules can be configured to record received transaction messages and transaction states of received transaction messages. The transaction exchanger can be configured to notify the information queue module and the one or more local client applications that a transaction message has been transmitted. The transaction exchanger can be configured to encrypt one or more blocks of normative transaction information. The envelope can be configured to provide descriptive information of the encryption. The transaction exchanger can be configured to digitally sign the one or more blocks of normative transaction information. The envelope can be configured to provide descriptive information of the digital signature.

According to the second aspect, the envelope of the normative transaction information can include message processing history for the transaction message. The message processing history can comprise information components. The transaction exchanger can be configured to process individual information components of the message processing history. The message processing history can include a record of a change in state of the transaction message. The envelope of the normative transaction information can include addressing and routing information for the transaction message. The envelope of the normative transaction information can include transaction history of the transaction. The transaction exchanger can be in communication with a data storage module. The data storage module can be configured to store information transmitted and received by the transaction exchanger.

According to a third aspect of the present invention, a method of communicating information associated with a transaction includes the steps of: a.) communicating local transaction information using one or more local data formats; b.) transforming the local transaction information in the one or more local data formats into transaction information in one or more common data formats; c.) communicating the transaction information in the one or more common data formats; and d.) transforming the transaction information in the one or more common data formats into remote transaction information in one or more remote data formats to thereby communicate the local transaction information.

According to the third aspect, the method can include the steps of: e.) transforming remote transaction information in the one or more remote data formats into transaction information in the one or more common data formats; f.) communicating the transaction information in the one or more common data formats; and g.) transforming the transaction information in the one or more common data formats into the local transaction information in the one or more local data formats to thereby communicate the remote transaction information. The transaction can comprise a compound transaction. The method can include the step of h.) suspending the compound transaction until a predetermined condition is satisfied. The predetermined condition can comprise, for example, a time limit. The method can include the steps of: i.) determining a status of a component of the compound transaction; and j.) exchanging a status of a component of the compound transaction.

According to the third aspect, the one or more common data formats can include information configured to allow apprehension of the transaction. The method can include the step of: k.) automatically initiating, participating in and completing the transaction. The transaction can be associated with at least one of a commercial transaction, a legal transaction, a financial transaction, a governmental transaction, a medical transaction, a civic transaction, and a social transaction. According to an alternative exemplary embodiment of the third aspect, the transaction can be associated with at least one of a banking industry, a trading/securities/financial industry, a healthcare industry, a telecommunication industry, and a satellite service industry. According to another exemplary embodiment of the third aspect, the transaction can be associated with at least one of an energy industry, a utility industry, a manufacturing industry, an automotive industry, and a pharmaceutical industry.

According to the third aspect, the method can include the step of: l.) administering the transaction. For example, step (l) can include the step of: m.) administering the transaction via automated messages. The transaction information in the one or more common data formats can include at least one of unique transaction ID tags, envelope ID tags, and message ID tags. The method can include the steps of: n.) ascertaining a status of the transaction, based on the at least one of the unique transaction ID tags, envelope ID tags and message ID tags; o.) aggregating local and remote transaction information to form a fully distributed data store; p.) querying the fully distributed data store; and q.) generating a standardized XML document from at least one of the local transaction information, the transaction information and the remote transaction information. The standardized XML document can be associated with a transaction. Step (q) can include the step of: r.) combining two or more standardized XML documents into one standardized XML document that is used for non-repudiation of a business transaction.

According to a fourth aspect of the present invention, a method of communicating information includes the steps of: a.) communicating transaction information in one or more local data formats; b.) transforming the transaction information in the one or more local data formats into an intermediate data format; c.) converting the transaction information in the intermediate data format into a common data format using a normative data model configured to generate normative transaction information; d.) generating a transaction message by providing an envelope for the normative transaction information in the common data format; and e.) communicating the transaction message in the common data format.

According to the fourth aspect, the method can include the steps of: f.) transforming transaction information in the intermediate data format into the one or more local data formats; g.) converting normative transaction information in the common data format into the intermediate data format; h.) processing the envelope for the normative transaction information in the common data format; i.) receiving the transaction message; and j.) processing the transaction information using the one or more local data formats. The intermediate data format can comprise, for example, HTML, XHTML or XML or the like. The method can include the steps of: k.) processing transformed transaction information using the intermediate data format; and l.) validating the normative transaction information. Step (l) can include the steps of: m.) validating the normative transaction information to ensure that the normative transaction information includes data required by mandatory data fields; and/or n.) validating the normative transaction information to ensure that the normative transaction information includes data required by cross-data field constraints.

According to the fourth aspect, the method can include the steps of: o.) customizing the validated normative transaction information to generate enriched normative transaction information; p.) storing transmitted transaction messages and transaction states of the transmitted transaction messages; q.) storing received transaction messages and transaction states of received transaction messages; r.) generating a notification that a transaction message has been one or transmitted and received; s.) encrypting one or more blocks of normative transaction information, wherein the envelope is configured to provide descriptive information of the encryption; and t.) digitally signing the one or more blocks of normative transaction information, wherein the envelope is configured to provide descriptive information of the digital signature. The envelope of the normative transaction information can include message processing history for the transaction message. The message processing history can comprise information components. The method can include the step of: u.) processing individual information components of the message processing history. The message processing history can include a record of a change in state of the transaction message. The envelope of the normative transaction information can include addressing and routing information for the transaction message. The envelope of the normative transaction information can include transaction history of the transaction.

According to a fifth aspect of the present invention, a system for communicating transaction information associated with a transaction includes a plurality of client application means distributed among one or more local client application means and one or more remote client application means. The system includes a plurality of means for transaction exchanging distributed among one or more local transaction exchanging means and one or more remote transaction exchanging means. The one or more local transaction exchanging means are configured to communicate the transaction information with the one or more local client application means, with which the one or more local transaction exchanging means are associated, using one or more local data formats. The one or more remote transaction exchanging means are configured to communicate the transaction information with the one or more remote client application means, with which the one or more remote transaction exchanging means are associated, using one or more remote data formats. The one or more local transaction exchanging means are configured to transform the transaction information in the one or more local data formats into one or more common data formats that are shared with the one or more remote transaction exchanging means. The one or more remote transaction exchanging means are configured to transform the transaction information in the one or more common data formats into the one or more remote data formats. The transaction information from the one or more local client application means is communicated to the one or more remote client application means.

According to the fifth aspect, the one or more remote transaction exchanging means can be configured to transform transaction information in the one or more remote data formats into the one or more common data formats that are shared with the one or more local transaction exchanging means. The one or more local transaction exchanging means can be configured to transform the transaction information in the one or more common data formats into the one or more local data formats. The transaction information from the one or more remote client application means can be communicated to the one or more local client application means. The transaction can comprise a compound transaction. The one or more local transaction exchanging means and the one or more remote transaction exchanging means can be configured to suspend the compound transaction until a predetermined condition is satisfied. The predetermined condition can comprise, for example, a time limit. Each of the one or more local transaction exchanging means and the one or more remote transaction exchanging means can be configured to determine a status of a component of the compound transaction. Each of the one or more local transaction exchanging means and the one or more remote transaction exchanging means can be configured to exchange a status of a component of the compound transaction.

According to the fifth aspect, the transaction can be supported by the plurality of client application means. The one or more common data formats can include information configured to allow the one or more remote client application means to apprehend the transaction. The system can be configured to facilitate initiation of, participation in and completion of the transaction automatically. The transaction can be associated with at least one of a commercial transaction, a legal transaction, a financial transaction, a governmental transaction, a medical transaction, a civic transaction, and a social transaction. According to an alternative exemplary embodiment of the fifth aspect, the transaction can be associated with at least one of a banking industry, a trading/securities/financial industry, a healthcare industry, a telecommunication industry, and a satellite service industry. According to an additional exemplary embodiment of the fifth aspect, the transaction can be associated with at least one of an energy industry, a utility industry, a manufacturing industry, an automotive industry, and a pharmaceutical industry.

According to the fifth aspect, the plurality of transaction exchanging means can be associated with a means for administering transactions. The transaction administering means can be configured to administer each transaction exchanging means. The transaction administering means can be configured to administer each transaction exchanging means via automated messages. The plurality of transaction exchanging means can comprise processing modules that are configured to be updated using secure administrative messages. Configuration information of each transaction exchanging means can be configured to be updated using the secure administrative messages. Transaction information passed between the plurality of transaction exchanging means can include at least one of unique transaction ID tags, envelope ID tags, and message ID tags. An administrative message can be configured to query one or more transaction exchanging means to ascertain a status of the transaction, based on the at least one of the unique transaction ID tags, envelope ID tags and message ID tags.

According to the fifth aspect, each transaction exchanging means can include information configured to form a fully distributed data storage means in aggregate with information associated with other transaction exchanging means. An administrative message can be configured to query the fully distributed data storage means. Information can be generated into a standardized XML document or the like. For example, standardized XML documents generated from information contained in two or more transaction exchanging means can be combined into one standardized XML document that is used for non-repudiation of a business transaction. Customized processes can be associated with one or more transactions. The customized processes can be distributed via administrative messages. The administrative messages can be configured to utilize message security and provide a definable block in an envelope. The definable block can be configured to provide parameters for the customized processes.

According to a sixth aspect of the present invention, a transaction exchanger includes means for queuing information. The information queuing means is configured to communicate transaction information in one or more local data formats with one or more local client applications. The transaction exchanger includes means for formatting in communication with the information queuing means. The formatting means is configured to transform the transaction information in the one or more local data formats into a data format associated with the transaction exchanger. The transaction exchanger includes means for mapping in communication with the formatting means. The mapping means is configured to convert the transaction information in the data format associated with the transaction exchanger into a common data format that is shared with at least one other transaction exchanger, using a normative data model configured to generate normative transaction information. The transaction exchanger includes means for processing message in communication with the mapping means. The message processing means is configured to generate a transaction message by providing an envelope for the normative transaction information in the common data format. The transaction exchanger includes one or more means for communicating in communication with the message processing means. The one or more communicating means are configured to communicate the transaction message with at least one other transaction exchanger.

According to the sixth aspect, the formatting means can be configured to transform the transaction information in a data format associated with the transaction exchanger into the one or more local data formats. The mapping means can be configured to convert the normative transaction information in the common data format into a data format associated with the transaction exchanger. The message processing means can be configured to process the envelope for the normative transaction information in the common data format. The message processing means can be configured to execute predetermined next actions and processing demands imposed by the at least one other transaction exchanger. The one or more communicating means can be configured to receive the transaction message provided by the at least one other transaction exchanger.

According to the sixth aspect, the transaction exchanger can include a first custom means for processing in communication between the information queuing means and the formatting means. The first custom processing means can be configured to process the transaction information using the one or more local data formats. The data format associated with the transaction exchanger can comprise, for example, HTML, XHTML or XML or the like. The transaction exchanger can include a second custom means for processing in communication between the formatting means and the mapping means. The second custom processing means can be configured to process transformed transaction information using the data format associated with the transaction exchanger. The transaction exchanger can include means for validating in communication between the mapping means and the message processing means. The validating means can be configured to validate the normative transaction information. The validating means can be configured to validate the normative transaction information to ensure that the normative transaction information includes data required by mandatory data fields and/or cross-data field constraints.

According to the sixth aspect, the transaction exchanger can include means for enriching data in communication between the validating means and the message processing means. The data enriching means can be configured to customize the validated normative transaction information to generate enriched normative transaction information. The one or more communicating means can be configured to record transmitted transaction messages and transaction states of the transmitted transaction messages. The one or more communicating means can be configured to record received transaction messages and transaction states of received transaction messages. The transaction exchanger can be configured to notify the information queuing means and the one or more local client applications that a transaction message has been transmitted. The transaction exchanger can be configured to encrypt one or more blocks of normative transaction information. The envelope can be configured to provide descriptive information of the encryption. Additionally or alternatively, the transaction exchanger can be configured to digitally sign the one or more blocks of normative transaction information. The envelope can be configured to provide descriptive information of the digital signature.

According to the sixth aspect, the envelope of the normative transaction information can include message processing history for the transaction message. The message processing history can comprise information components. The transaction exchanger can be configured to process individual information components of the message processing history. The message processing history can include a record of a change in state of the transaction message. The envelope of the normative transaction information can include addressing and routing information for the transaction message. The envelope of the normative transaction information can include transaction history of the transaction. The transaction exchanger can be in communication with a means for storing data. The data storing means can be configured to store information transmitted and received by the transaction exchanger.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating system for system for communicating transaction information, in accordance with an exemplary embodiment of the present invention.

FIG. 2 is a diagram illustrating a transaction exchanger, in accordance with an exemplary embodiment of the present invention.

FIG. 3 is a diagram illustrating a transaction message, in accordance with an exemplary embodiment of the present invention.

FIG. 4 illustrates a one-step transaction using an activity diagram, in accordance with an exemplary embodiment of the present invention.

FIG. 5 illustrates a one-step transaction with a business acknowledgment, using an activity diagram, in accordance with an exemplary embodiment of the present invention.

FIG. 6 illustrates a one-step transaction with two business acknowledgments, using an activity diagram, in accordance with an exemplary embodiment of the present invention.

FIG. 7 illustrates a request/response transaction, using an activity diagram, in accordance with an exemplary embodiment of the present invention.

FIG. 8 is a flowchart illustrating steps for communicating information associated with a transaction, in accordance with an exemplary embodiment of the present invention.

FIG. 9 is a flowchart illustrating steps for communicating information, in accordance with an alternative exemplary embodiment of the present invention.

### DETAILED DESCRIPTION OF THE PREFERRED EMBODIMENTS

Exemplary embodiments of the present invention are directed to a system and method for exchanging transaction information among remote transaction exchange applications for participating in, facilitating and/or completing transactions. According to exemplary embodiments, the system is comprised of a distributed application platform that is configured to handle defined, computerized business transactions among a community of disparate companies. The system can integrate to existing client environments, regardless of the client's technology choices and data formats. The system is configured to convert existing client data into a common model data that can be shared among all other clients. The system includes the functions of a robust message system, and does not require a centralized processor or centralized database. Exemplary embodiments of the present invention can operate over a multi-node dispersed transaction environment.

The system provides the capability to develop multi-enterprise business transaction exchange applications, with minimal impact on each client. More particularly, the system can be used by a controlling manager, such as, for example, a solution provider, that builds, distributes and manages the business transaction exchange applications among a group of clients. The solution providers can define global transaction attributes, such as, for example, the transactions supported, global validation rules, security, message processes, data stores and common services, that are shared with each client. However, each client can retain autonomy over their (perhaps unique and/or proprietary) transactions and data formats. Each client can maintain a local store of transactions that are transmitted and received. Additionally, each client can use their existing file formats and transport software, as the system uses the client's existing infrastructure. Consequently, little or no changes are required for the client's applications.

Thus, the solution provider can design the transaction exchange applications using exemplary embodiments of the present invention to build an application that can be distributed and installed at all desired client sites. Each of the transaction exchange applications is configured to communicate with other transaction exchange applications in one or more common data formats that are shared and understood by all of the transaction exchange applications. The transaction exchange application at a client's site is also integrated to the local client's data formats, transport protocols, and any customized requirements. The local transaction exchange applications are then configured to convert or otherwise transform the proprietary transaction information from the local client application into the common data format so that the information can be communicated to another, remote transaction exchange application. Once received, the remote transaction exchange application can convert or otherwise transform the transaction information in the common data format to the data format required by the remote client application. Thus, according to exemplary embodiments, all clients can send and receive transaction information to and from other clients to perform inter-corporate, multi-enterprise automated business or other suitable transactions.

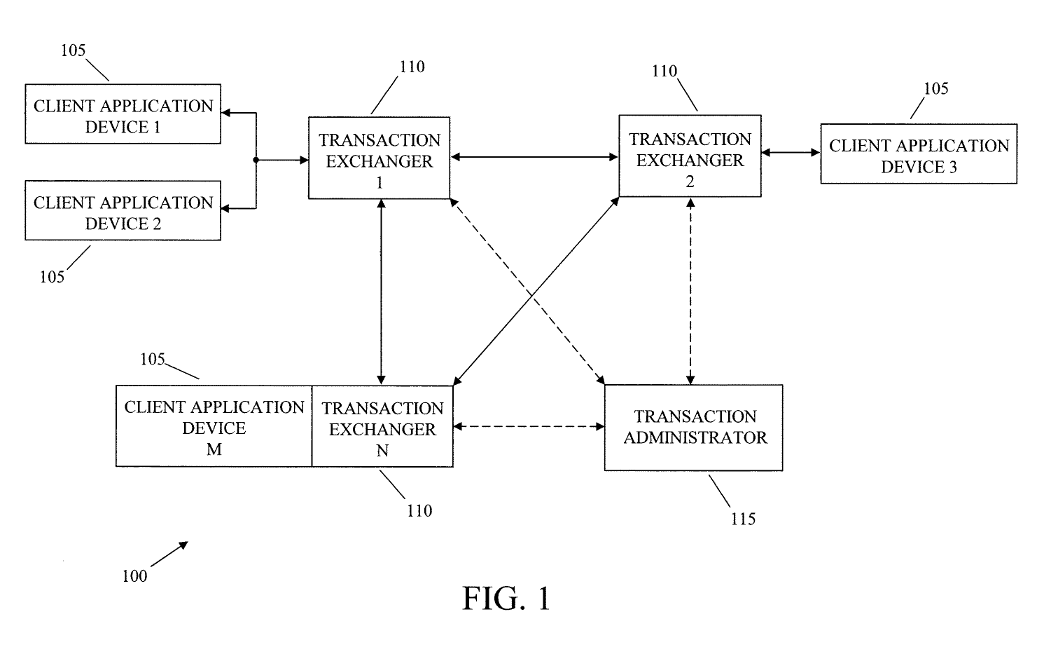

These and other aspects of the present invention will now be described in greater detail. FIG. 1 is a diagram illustrating system 100 for system for communicating transaction information, in accordance with an exemplary embodiment of the present invention. The transaction information can include any suitable information or data associated with a particular transaction, including, but not limited to, a request for availability of goods or services, a request to purchase goods or services, a request for the shipment of goods, a request for proposal, a response to such request and the like. The system 100 includes a plurality of client application devices 105 (e.g., client application device 1, client application device 2, client application device 3, . . . , client application device M, where M can be any suitable number). The client application devices 105 can be comprised of any suitable type of software or computer program, including any system requirements, installed or otherwise accessible to a client. The client application devices 105 can reside either locally or at a remote location. For example, according to exemplary embodiments, the client application devices 105 can be distributed among one or more local client application devices and one or more remote client application devices. The system 100 also includes a plurality of transaction exchangers 110 (e.g., transaction exchanger 1, transaction exchanger 2, . . . , transaction exchanger N, where N can be any suitable number). The plurality of transaction exchangers 110 are distributed among one or more local transaction exchangers and one or more remote transaction exchangers.

For purposes of illustration and not limitation, the first transaction exchanger 110 (i.e., transaction exchanger 1) can be a local transition exchanger. Consequently, for the present illustration, the second through Nth transaction exchangers 110 (i.e., transaction exchanger 2, . . . , transaction exchanger N) can be remote transaction exchangers with respect to the (local) first transaction exchanger 110. Additionally, the first and second client application devices 105 (i.e., client application device 1 and client application device 2) can be local client application devices with respect to the first (local) transition exchanger 110. Therefore, for the present illustration, the second and third through Mth client application devices 105 (i.e., client application device 2, client application device 3, . . . , client application device M) can be remote client application devices with respect to the (local) first and second client application devices 105.

More particularly, the one or more local transaction exchangers 110 are configured to communicate transaction information with the one or more local client application devices 105, with which the one or more local transaction exchangers 110 are associated, using one or more local data formats. The one or more remote transaction exchangers 110 are configured to communicate the transaction information with the one or more remote client application devices 105, with which the one or more remote transaction exchangers 110 are associated, using one or more remote data formats. In other words, each transaction exchanger 110 is a local transaction exchanger with respect to itself. The client application device 105 is a local client application device with respect to the local transaction exchanger 110 with which the client application device 105 is associated. Consequently, any transaction exchangers 110 not located locally are remote transaction exchangers 110 with respect to the local transaction exchanger 110. Additionally, any client application devices 105 not located locally are remote client application devices 105 with respect to the local client application device 105 and the associated local transaction exchanger 110.

Each client application device 105 communicates with the associated transaction exchanger 105 using one or more local data formats. In other words, each transaction exchanger 110 understands the one or more local data formats used by the client application device 105 with which the transaction exchanger 110 is associated. For example, each client application device 105 can be a proprietary, customized or otherwise unique user application that uses proprietary, customized or otherwise unique data formats to undertake and process a transaction. The local data format of each (local) client application device 105 may not be understood or otherwise compatible with local data formats used by other (remote) client application devices 105. Therefore, according to exemplary embodiments, the one or more local transaction exchangers 110 are configured to transform the transaction information in the one or more local data formats into one or more common data formats that are shared with the one or more remote transaction exchangers 110. Thus, each transaction exchanger 110 can convert the transaction information in the local data format used by the associated client application device 105 into a data format that is understood and used by all transactions exchangers 110. Such a common data format allows each transaction exchanger 110 to communicate and share data or other messages with one or more other transaction exchangers 110.

For example, for purposes of illustration and not limitation, the first transaction exchanger 110 can transform the transaction information from the first client application device 105 from the local data format used by the first client application device 105 to the common data format used by the transaction exchangers 110. Once transformed, the first transaction exchanger 110 can transmit or otherwise communicate the transaction information in the common data format to another transaction exchanger 110, such as the second transaction exchanger 110. When the second transaction exchanger 110 receives the transaction information in the common data format, the second transaction exchanger 110 is configured to transform the transaction information in the common data format into the data format used by the third client application device 105 with which the second transaction exchanger 110 is associated. In other words, the one or more remote transaction exchangers 110 can transform or otherwise convert the transaction information in the one or more common data formats into the one or more remote data formats. Thus, according to exemplary embodiments, the transaction information from the one or more local client application devices 105 can be communicated to the one or more remote client application devices 105 for participating in, facilitating and/or completing a transaction, without regard to the data formats used by each of the client application devices 105.

Conversely, the one or more remote transaction exchangers 110 are configured to transform the transaction information in the one or more remote data formats into the one or more common data formats that are shared with the one or more local transaction exchangers 110. For example, for purposes of illustration and not limitation, the second transaction exchanger 110 can transform the transaction information from the third client application device 105 from the local data format used by the third client application device 105 to the common data format used by the transaction exchangers 110. Once transformed, the second transaction exchanger 110 can transmit or otherwise communicate the transaction information in the common data format to another transaction exchanger 110, such as the first transaction exchanger 110. When the first transaction exchanger 110 receives the transaction information in the common data format, the first transaction exchanger 110 is configured to transform the transaction information in the common data format into the data format used by the first client application device 105 with which the first transaction exchanger 110 is associated. In other words, the one or more local transaction exchangers 110 are configured to transform the transaction information in the one or more common data formats into the one or more local data formats that are used by the local client application devices 105 associated with the local transaction exchanger 110. Thus, according to exemplary embodiments, the transaction information from the one or more remote client application devices 105 can be communicated to the one or more local client application devices 105 for participating in, facilitating and/or completing the transaction, regardless of the data formats used by each of the client application devices 105. For example, each client can send and receive transaction information to and from other clients to perform inter-corporate, multi-enterprise automated business or other suitable transactions via the transaction exchangers 110 according to exemplary embodiments of the present invention.

As can be seen in FIG. 1, the communication connections between the transaction exchangers 110 form a network. A community of enterprises that share a specific set of automated business transactions using the transaction exchangers 110 is referred to herein as a Members-Only Interconnect (MOI). MOIs can be set up to serve a wide range of transaction-specific communities, from some that are very large and global, such as, for example, the community of banks that need to process cross-border payment transactions, to small local communities such as, for example, a small regional medical community including doctors, pharmacies, hospitals, payers, and the like. Each member in an MOI sends/receives standardized transaction information from/to an internal application that is meant to process that information. The client application devices 105 can comprise these internal applications.

A more general architecture than the MOI is referred to as a Service-Oriented Architecture (SOA). An SOA is a peer-to-peer network comprised of nodes that can usually be divided into consumer-nodes, which consume the processing done within the SOA, and service nodes, which provide an identifiable, single-purpose function to support the transaction. An MOI can be considered as containing a special, stylized distributed application—the “business transaction application” (BTA)—that a user has created to support a specific set of business transactions. The BTA is built by configuring and customizing the transaction exchangers 110. Thus, the system 100 is a fully-distributed application based on an SOA. Consequently, there is no central process, but, rather, a peer-to-peer network of applications connected together and communicating through the transaction exchangers 110. The consumers of the BTA are the client application devices 105 that are creating, sending, receiving and processing the standardized information contained in the business transaction. This information is contained in a message, which is referred to here as a transaction message. The structure and format of transaction messages exchanged between transaction exchangers 110 in a BTA is fixed and defined by the users. The (local) client application devices 105 interact with a local transaction exchanger 110 through message queues. In addition to client application devices 105, the MOI can contain a number of specialized service applications that perform specific functions that support the execution of the given business transaction, such as, for example, authentication, coordinated time-stamping, logging services, credit checks, non-repudiation, data augmentation, routing services, and the like.

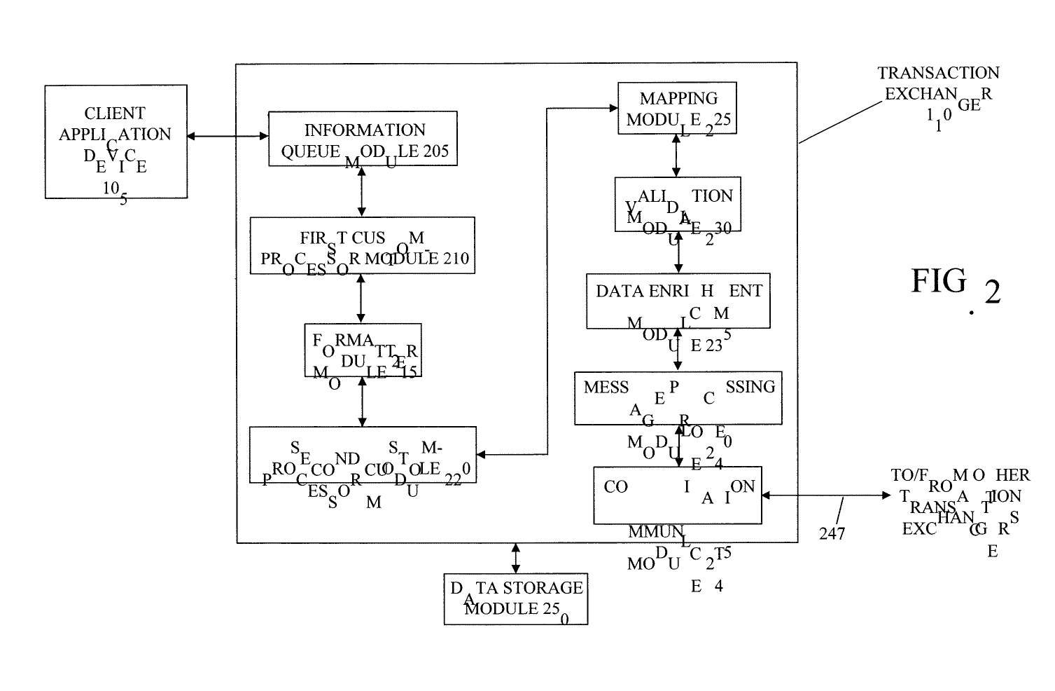

To convert between the local and common data formats so that transaction information can be passed from the local client application device 105 to the remote client application device 105, suitable message processing is performed in each transaction exchanger 110. FIG. 2 is a diagram illustrating a transaction exchanger 110, in accordance with an exemplary embodiment of the present invention. The transaction exchanger 110 includes an information queue module 205. The information queue module is configured to communicate transaction information in one or more local data formats with the client application device 105, although the information queue module 205 can be in communication with any suitable number of (local) client application devices 105. In other words, the information queue module 205 is configured to handle messages coming from the (local) client application device 105.

To interface and communicate with the (local) client application devices 105, the transaction exchangers 110 use message queues that are referred to herein as “Abstract Queues,” as these Abstract Queues can standardize and abstract the interface between the transaction exchangers 110 and a wide variety of message delivery mechanisms. From the viewpoint of the transaction exchanger 110, an Abstract Queue can pass the message the Abstract Queue receives from either the (local) client application device 105 or from other (remote) transaction exchangers 110, and can receive messages from the transaction exchanger 110 to be sent either to a (local) client application device 105 or to a (remote) transaction exchanger 110. The transaction exchanger 110 can interact with an Abstract Queue through simple APIs, which contain a small amount of basic information about the message and a reference to the bytes that make up the message. The supplied information is substantial enough so that the transaction exchanger 110 or the Abstract Queue can determine how to process the referenced message. Each Abstract Queue can have an associated error queue on which are placed messages that are not able to be processed for some reason, along with an error message (e.g., in a fixed format) describing the error. The error queues can be, for example, folders on the (local) transaction exchanger 110 where the files are placed. Such an error queue is at a level higher than the delivery mechanism error queue, which is specific to the delivery mechanism. For example, if the delivery mechanism is a JMS message broker, and the message cannot reach the intended message broker queue, then the message will be placed in the message broker's error queue.

Additionally, for each of the information queue module 205 and the communication module 245 (discussed below), the transaction exchanger 110 instantiates a queue listener as part of an Abstract Queue. The queue listener “listens” for or otherwise detects a message received by an Abstract Queue. The respective queue listener can send a signal to the information queue module 205 or the communication module 245 when the respective queue listener has received or detected a message. Such signals can be the event that begins processing by the transaction exchanger 110.

An Abstract Queue has the general qualities of a queue—for example, the ability to add and remove items, to create a listener for the queue and the like—but is abstract in the sense that it “sits on top” of the details of the mechanism that is implemented to send and receive messages (either to the client application device 105 or to other transaction exchangers 110). For example, the implementation of an Abstract Queue can be a standard JMS-based message broker or MOM, a Web service, FTP, an API call to an end user application, a database query, or the like.

One aspect of the Abstract Queue is to loosely couple the delivery mechanism and the business transaction in the transaction exchanger 110. There is no tight coupling with a MOM backbone as there is with many ESBs, so there is no requirement that the transaction exchangers 110 use a particular vendor or even a particular delivery mechanism to participate in a business transaction. Thus, the transaction exchangers 110 can be adapted to whatever transport mechanism is in place and being used by the client application devices 105.

Another aspect of the Abstract Queue is that it allows connection to the MOI using configuration tools, rather than requiring software coding. For example, a set of pre-built Abstract Queue adapters can be configurable simply by setting suitable properties. If changes in delivery strategy are required by a transaction exchanger 110, changes can be made to a different Abstract Queue type and suitable properties can be set, rather than re-coding the transaction exchangers 110.

The Abstract Queue properties can depend on, for example, the Abstract Queue type, which will be based on the particular client application device 105. Some properties of the Abstract Queues include the Abstract Queue name. Abstract queues are addressable entities within the transaction exchanger 110, and can therefore use a unique (within the transaction exchanger 110) name to identify them. The name can be any suitable designation or address, such a combination of alphanumeric characters, an IP address, or the like. For Abstract Queues for connecting with other transaction exchangers 110, such a name or designation should be available to other transaction exchangers 110 for addressing purposes.

According to an exemplary embodiment, the Abstract Queues can support guaranteed delivery. A delivery mechanism that does not support guaranteed delivery (e.g., FTP) may require additional processing by the sending/receiving transaction exchangers 110. For example, there might be additional properties required so that the sending transaction exchanger 110 can do the work that a normal MOM would do. For example, the transaction exchanger 110 can temporarily persist the message, wait for a callback that indicated the message was received (e.g., the message acknowledgment), and then delete the message from temporary persistent storage. However, if the message was not received within a certain period of time, the transaction exchanger 110 can re-send the message, up to the maximum number of retries. Alternatively, “alert” properties can be established (e.g., Time To Alert, Alert Destination, Alert Text), so that if no acknowledgment is received within a certain time, then an alert occurs.

The Abstract Queues can also include suitable listener properties. The listener properties can define what the Abstract Queue is listening for, e.g., what is the triggering event. For example, for an FTP Abstract Queue type, the listener property can be the name of the folder where the Abstract Queue checks for new files. However, for a message broker, the listener properly can be the queue where the Abstract Queue checks for messages. For example, the MOI architecture can support asynchronous transactions through the use of Abstract Queues at each transaction exchanger 110. The arrival of a message at an Abstract Queue can be the trigger that causes the transaction exchanger 110 to process that message. Such an architecture provides a simple, loosely-coupled interaction framework for building business transactions between participants.

One of the advantages of Abstract Queues is that they allow BTAs to be built on a wide, diverse set of message protocols, including legacy transports, e.g., FTP, direct leased lines, and the like. Consequently, BTAs should not entail the large changes in infrastructure required by other service-oriented solutions, such as, for example, ESBs and the like. According to exemplary embodiments, there are numerous types of Abstract Queues that can be used for the transaction exchangers 110. One example of an Abstract Queue is a JMS-compliant message broker Abstract Queue. Such an Abstract Queue can encapsulate a standard JMS interface to a message broker. Most conventional message brokers are JMS compliant and can provide such an interface, e.g., SonicMQ, MQSeries, other open source products and the like. For example, Manta Ray, one such open source product, can be used with the transaction exchangers 110. Manta Ray is suited for the fully distributed, decentralized nature of an MOI, as Manta Ray is fully distributed, i.e., all processing is done within the Manta Ray client and there is no central bus server. Additional JMS-compliant Abstract Queues may be necessary, depending upon the application. For example, an Abstract Queue may be necessary for MQSeries message brokers, because of the widespread popularity of such a message broker in the financial community.

Another example of an Abstract Queue is an FTP Abstract Queue. For example, much business transaction information is sent and received through batch-oriented FTP processes. An Abstract Queue can be used to encapsulate such a mechanism for moving information. Two versions of the Abstract Queue can be used—one that treats the file to be sent or received via FTP as a single payload, the other that treats each record within a file as a separate payload. However, other configurations of the FTP Abstract Queue can be used. The FTP Abstract Queue can provide a significant amount of flexibility to the transaction exchanger 110. A (local) client application device 105 can send a file to an FTP-based Abstract Queue used by the information queue module 205. The Abstract Queue can then pass each record of the file as a payload to the information queue module 205. After the transaction exchanger 110 has processed these records, the records can be re-packaged by an FTP-based Abstract Queue used by the communication module 245 and sent using FTP to another transaction exchanger 110. Alternatively, the records can be sent as separate messages using, for example, a JMS-based Abstract Queue.

There are situations in which two parties may desire to exchange data via FTP. In such an example, the user desires to send a file via FTP using the MOI architecture and transaction exchangers 110. An FTP Abstract Queue can be set up at the transaction exchanger 110 that is directed to the (local) client application device 105. For example, the FTP Abstract Queue can check a particular directory (defined by a property) to “listen” for incoming information. When the client application device 105 adds a file to the directory, the FTP Abstract Queue can activate the transaction exchanger 110 as though a message were added to a queue.

Certain header information can be provided to the FTP Abstract Queue, such as, for example, the transaction type, the message type, the recipient's address and the like. The FTP Abstract Queue can combine such information (the message metadata) with the non-normative data (the message content) to create a message that can be processed by the transaction exchanger 110, the last step of which is to place the message on a FTP Abstract Queue that is in communication with the other (remote) transaction exchangers 110. The “network-facing” FTP Abstract Queue can then send the file to the appropriate destination using the FTP protocol. The FTP Abstract Queue can send the bytes via FTP to the destination, which can be simply a directory. The destination transaction exchanger 110 can include an FTP Abstract Queue set up to listen on that directory. When the file arrives, the transaction exchanger 110 can act as though a message was received on a queue, and perform processing to reconstitute the file as a message that the transaction exchanger 110 can understand. At that point, subsequent transaction exchanger 110 processing begins, as discussed below. It should be noted that FTP can be used to batch together multiple messages in one file, and have the receiving transaction exchanger 110 reconstitute the file as individual messages.

Another example of an Abstract Queue is a direct-line Abstract Queue. Much of current inter-enterprise transactions between applications is performed between client applications at the users' locations and a large centralized server at a remote server location. These client/server systems generally use direct leased line connections. The direct-line Abstract Queue can wrap the underlying direct line messaging protocol, allowing the transaction exchangers 110 to be used with such legacy systems.

A further example of an Abstract Queue is a web services/SOAP Abstract Queue. Such an Abstract Queue can use SOAP to handle the transmission of a message. In many cases, these web service Abstract Queues can be used to handle request/response messages when specific queries need a direct response. Many internal system messages can also utilize this type of Abstract Queue. For example, an instantiation of a web service Abstract Queue can handle interactions with the (local) client application device 105 that, for efficiency, can utilize the normative XML messages (discussed below).

Another example of an Abstract Queue is a database integration Abstract Queue. An advantage of the MOI and architecture of system 100 is the ease of integrating the transaction exchangers 110 with internal applications and databases. The database integration Abstract Queue can access the message payload to make it simpler for users to send or receive messages directly from/to an internal database. For example, to send a message, the database integration Abstract Queue can map data from an internal database to its own version of the message payload object model. The Abstract Queue can then create a normative message (as discussed below) for that payload and pass the message onto the transaction exchanger 110. Such a process would be reversed to receive and store a message into an internal database. Substantially all of the capabilities necessary to interact with the internal database can be supported. Such functionality can include support for any JDBC driver so that many forms of tabular data can be accessed. It should be noted that the integration to internal applications is separated from the central mapping in the transaction exchanger 110, so that management of the MOI can be performed (including, for example, handling injection and versioning (discussed below)), without interfering with the local customization efforts undertaken by users.

According to an exemplary embodiment, the messages communicated between the (local) client application device 105 and the information queue module 205 can be referred to as “queue messages.” The queue message is a message received from an Abstract Queue. The queue message can be comprised of, for example, a minimal header and the message data. The header in a queue message can be different than the header used for other message types used by the transaction exchanger 110, as discussed below. The queue header can include a minimal amount of information, such as which formatter to use (if needed), the message type, the transaction type, and other like information. The header information can be imparted to the message via the Abstract Queue. The message data in a queue message is simply an array of bytes. Nothing else need be assumed about the payload. As discussed below, for queue messages coming from the (local) client application device 105, the formatter module 215 can transform the queue messages into corresponding non-normative information, such as, for example, XML messages.

The transaction exchanger 110 optionally includes a first custom-processor module 210 in communication with the information queue module 205. The first custom-processor module 210 is configured to process the transaction information using the one or more local data formats used by the (local) client application device 105. The first custom-processor module 210 is provided to allow users to add customized processing capabilities to the transaction exchanger 110. For example, the user can configure the first custom-processor module 210 to perform a series of actions on the transaction information while that information is still in the local data format (e.g., add or modify the transaction information, re-format the transaction information, and the like). According to an exemplary embodiment, since the user can add functionality to their own process module, a wide variety of local processing can be supported, such as, for example, data enrichment, complex business rule authorizations, and the like.

More particularly, according to an exemplary embodiment, the first custom-processor module 210 can be responsible for executing a series of steps called an “action list” on the message content (or payload) that is in the local data format. The first custom-processor module 210 can perform, for example, validation, enforce local security policies, perform data enrichment, and the like, as desired by the user. An action list defines the steps that the first-custom processor module 210 follows for a message. Action lists can be associated with a particular message type. Action list templates can be provided that can be used as a starting point for users to configure their action lists. The user can configure the appropriate parameters for the action lists, such as, for example, by specifying queue names, log file names, and the like. According to exemplary embodiments, no software coding is necessary for performing such a configuration. The action list can specify that certain steps are required or that certain steps can be skipped that are not required. Additional steps can be added to an action list at any time to extend the processing that occurs with the first custom-processor module 210. There is no restriction on the sequence in which steps can be defined for processing. However, the user should ensure that the sequence of steps are proper and logical. Separate action lists can reside in each transaction exchanger 110.

According to an exemplary embodiment, one or more predefined steps can be used to create an action list for the first custom-processor module 210. For example, such predefined steps can include, but are not limited to: validate the message content; create an entry in a local log file; send a different message (different message type), for example, to creates a new transaction; send the message to an enterprise-facing Abstract Queue (discussed below), which can trigger additional processing via another application, web service, or the like; store the message and its state in a repository associated with the transaction exchanger 110; and other like predefined steps. However, there is no requirement that any of these steps be used. Each step may have different properties defined. For example, the log step might have properties for the log file location, while the send reply step might specify the message type to send, and the like. In addition to using such predefined steps, the user can create additional customized steps can be used when building action lists.

According to an exemplary embodiment, steps can be processed in the order in which they are defined in the action list, in a linear sequence. However, conditional branching, forking and joining can also be used. Additionally, steps can be synchronous, meaning that processing is blocked until a step is complete, although asynchronous processing can also be used. Furthermore, a step can be flagged as a long-duration step (not to be confused with long-running transactions) if the processing for that step is not expected to return immediately. For example, such flagging can enable the inclusion of manual processing, or some other process that takes hours or even days to complete. Note that this facility may provide the “look and feel” of an asynchronous process, but is actually a synchronous process. For a long-duration step, the message state can be persisted to a repository associated with the transaction exchanger 110 (e.g., the data storage module 250 discussed below), and a “listener” process can be established to wait for a return from the sub-processing that was invoked. Long-duration steps can include additional properties specifying, for example, the maximum time to wait and the error queue to notify if the sub-process exceeds such a limit.

In the event of a failure of one or more steps performed by the action lists, the action list can define which of the following can happen when a step fails: all further processing stops, and another action (from a short list) may be invoked, such as sending the message to an error queue; a warning is logged (either directly in the repository or via an administrative message), and processing continues with the next step in the Local Processor action list; or the failure is ignored. Additional or alternative error events can occur when one or more of the steps to be performed by the action list fail.

The transaction exchanger 110 includes a formatter module 215 in communication with the first custom-processor module 210 (or the information queue module 205 if no first custom-processor module 210 is used or present). The formatter module 215 is configured to transform the transaction information in the one or more local data formats into a data format associated with the transaction exchanger 110. The data format associated with the transaction exchanger 110 can be any suitable data format that can be used by the transaction exchanger 110. According to an exemplary embodiment, the data format associated with the transaction exchanger is referred to herein as “non-normative information,” and can comprise HTML, XHTML, XML or any other suitable data format. Merely for purposes of discussion and illustration, XML will be used as an example of the non-normative information, although any other suitable data format can be used for the non-normative information. For example, messages processed within the transaction exchanger 110 can be well-formed XML documents. However, messages from the (local) client application device 105 can be in a variety of formats, e.g., EDI, a flat file, or any other proprietary or custom format. The formatter module 215 is configured to transform messages from/to such external formats to/from a non-normative XML message that the transaction exchanger 110 can understand and manipulate.

More particularly, the formatter module 215 can be responsible for performing a one-for-one “tokenization” or transformation of a non-XML message into an XML message (e.g., EDI to XML), and vice versa. For a “sending” transformation, the formatter module 215 can transform a queue message (e.g., non-XML) from the (local) client application device 105 into a non-normative XML message format that the transaction exchanger 110 can process. The transaction exchanger 110 can process the resulting non-normative XML message, because the transaction exchanger 110 uses a map between the non-normative XML message and a normative data model. For “receiving” transformations, the formatter module 215 can transform a non-normative XML message into a queue message (e.g., non-XML) that the (local) client application device 105 can process. The formatter module 215 can support any suitable transformation to/from the non-normative information (e.g., XML), such as, for example, EDIFACT, X12, FIN (or, more generally, SWIFT non-XML (ISO 7775)), fixed-length flat files, delimited flat files, FIX, and the like.

As used herein, a non-normative XML message is a well-formed XML message that conforms to an XML model that is part of the transaction exchanger 110 application map. The XML model is mapped to the normative data model (the object model). The difference between a non-normative XML message and a normative message is two-fold. First, a non-normative XML message is an XML message, while a normative message can be either an XML message or an instantiated message object. The second difference is one of degree. Both messages are represented by an XML model in the application map, but the XML model of the normative message can be considered to be an exact or substantially exact representation of the normative data model. The XML model of the non-normative XML message is a variation on the normative data model. For messages coming from the client application device 105, a non-normative XML message is the result of a one-for-one “tokenization” or transformation of a non-XML message into an XML message by the formatter module 215. In other words, the formatter module 215 takes the queue message (for example, EDI) and changes the form of the queue message to the non-normative information, such as XML or the like.

Producing a non-normative XML message is the first step in the process of creating a normative message. Each non-normative XML message is defined by an XML model in the application map, which is mapped to the normative data model (the object model). From such a mapping, a normative message can be created. For messages going to the client application device 105, part of the processing of the transaction exchanger 110 can involve converting a message into the correct non-normative XML message format so that it can be transformed by the formatter module 215 into a queue message.

According to exemplary embodiments, when a message is placed on an outbound queue of the client application device 105, the queue listener, based on information in the queue message it receives from the Abstract Queue, determines the formatter module 215 and format map to use for transforming the queue message appropriately into a non-normative XML message. Thus, each transaction exchanger 110 can support one or more formatter modules 215, with each formatter module 215 supporting a separate transformation format. Alternatively, a single formatter module 215 can support numerous transformation formats, with the appropriate format selected based on information in the queue message. It should be noted that the header may indicate that no formatting is required (e.g., the message is already in the correct format for the transaction exchanger 110 to process), in which case the processing performed by the formatter module 215 can be skipped. Once processed by the formatter module 215, the non-normative message is passed to the (optional) second custom-processor module 220.

For a message received by a transaction exchanger 105, the formatter module 215 is invoked after the (optional) second custom-processor module 220 is finished. The message is changed from a normative message to a non-normative message so that the formatter module 215 can process it. In addition, the formatter module 215 and the format map to be used can be determined based on information in the message header of the received transaction message. The formatter module 215 then transforms the message from a non-normative XML message into a queue message that is appropriate for the client application device 105.

The formatter module 215 can be a COTS product that can include a design-time component that can be used to create standard transformations that would be included as part of a service offering. The formatter module 215 can optionally use validation to confirm the accuracy of the transformation. For example, if the (local) client application device 105 requires a different or more stringent data format than that required by other MOI participants, such validation can be included in the format map used by the formatter module 215.

The transaction exchanger 110 can optionally include the second custom-processor module 220 in communication with the formatter module 215. The second custom-processor module 220 can be configured to process transformed transaction information using the data format associated with the transaction exchanger 110. According to an exemplary embodiment, the second custom-processor module 220 can be used to process the non-normative XML message transformed by the formatter module 215. The second custom-processor module 220 is provided to allow users to add customized processing capabilities to the transaction exchanger 110. For example, the user can configure the second custom-processor module 220 to perform a series of actions on the transaction information while that information is in the non-normative XML format (e.g., add or modify the transaction information, re-format the transaction information, and the like). As with the first custom-processor module 210, the second custom-processor module 220 can be responsible for executing one or more action lists on the non-normative XML message before further processing.

The transaction exchanger 110 includes a mapping module 225 in communication with the second custom-processor module 220 (or the formatter module 215 if no second custom-processor module 220 is used or present). The mapping module 225 is configured to convert the transaction information in the data format associated with the transaction exchanger 110 into a common data format that is shared with at least one other transaction exchanger 110, using a normative data model configured to generate normative transaction information. A normative message reflects the normative data model used by members of the MOI. The normative message can be either an instantiated message object (or set of objects), or an XML message. A normative message can be sent to and received from any other transaction exchanger 110 in the MOI. The normative data model can be based on industry-sponsored initiatives, such as HL7, FIX, SWIFT, RosettaNet, or the like, or can be defined as part of a new application. However, the normative data model can use any suitable type of mapping that is configured to transform or otherwise map the non-normative information into the normative information that can be shared with and understood by all of the transaction exchangers 110.

The normative data model is part of the application map that can be used by the transaction exchangers 110 to perform the transformation or conversion between the data of different formats. An application map can include, for example, a main map file, which simply points to the other files, an object model, and one or more XML maps, each of which is comprised of an XML model and a mapping between that model and the object model. There is generally one object model in an application map, although other object models can be used. The object model is the normalized data model for the transaction exchanger 110. The object model describes the message classes and their relationships. The object model can also contain the validation rules used by the validation module 230 (discussed below), as well as the business transaction definitions, and other suitable information. An XML map is comprised of an XML model and an object-model-to-XML-model mapping. An XML map can be used by the transaction exchanger 110 to transform an XML message to an instantiated message object based upon a given XML model, and to transform an instantiated message object back to XML. Such a facility allows the transaction exchangers 110 to handle multiple XML message formats that map to the same normative data. In other words, the object model represents the normative information shared by all members of the MOI, but each member can use different XML schemas to represent that data in an XML message.

The transaction exchanger 110 can also include a validation module 230 in communication with the mapping module 225. The validation module 230 is configured to validate the normative transaction information. For example, the validation module 230 can validate the normative transaction information to ensure that the normative transaction information includes data required by mandatory data fields and cross-data field constraints.

More particularly, validation is performed by the validation module 230 using validation rules specified by the user. The validation rules are part of the application map that each transaction exchanger 110 uses to participate in the MOI to ensure that messages exchanged between members are valid according to the commonly-accepted validation rules of the members. It should be noted that message validation is not a separate service performed as part of a process flow. Rather, each transaction exchanger 110 can validate any message. Such a mechanism can be contrasted with conventional approaches that require a central validation service that can become a process bottleneck, or that include a separate validation service as part of a process flow. Although performed by the validation module 230, validation can also be one of the steps that can be invoked by the action lists used by the first and second custom-processor modules 210 and 220, respectively. For example, the user can define when the validation should be invoked, in addition to the validation performed by the validation module 230 when sending a message. Since action lists are defined on a per message type basis, such a mechanism allows for validation to be invoked for one message type but not another. The user can also make validation an optional step for certain message types and a required step for others. The validation performed by the validation module 230 can be referred to as “local validation,” since the rules are defined and maintained for a particular transaction exchanger 110, rather than globally for all transaction exchangers 110. Local validation is generally not less stringent than global validation.

As discussed previously, the validation rules are part of the application map. The validation rules are associated with the normative data model (the object model), which is the “hub” of that map, rather than with the XML schemas to which the object model is mapped. The validation module 230 validates the objects, not the XML. Such an approach allows for more comprehensive data validation than is possible using an approach that simply validates XML against XML schema. In particular, the latter approach, as used by conventional architectures, cannot handle cross-field validation (for example, if Field A is null, Field B must be greater than $1,000). In contrast, the validation module 230 is capable of performing cross-field validation. Cross-field validation is a very common requirement for validating messages, but because it cannot be handled by validating against XML schema, it is generally handled by the business logic layer in conventional architectures. The validation approach used by the validation module 230 can, therefore, extend data validation into the realm of business rules to allow more business rules to be handled by simpler validation rules. According to one embodiment, the business rules include processing rules on a fund manager basis. A fund manager rule may state, for example, that the total value of a transaction should not exceed a predetermined amount.

The validation rules used by the transaction exchanger 110 can be of two types: field-level validation rules, that define the allowable data and format for a specific field; and cross-field validation rules, that can validate the data/format of one field in a message instance against the data/format of another field, as well as against global system values such as current date/time and the like. Validation rules can use regular relational (>, >, and the like) and logical (AND, OR, NOT and the like) operators, as well as parenthesis for grouping. Also, arithmetic operators (+, −, * and /) can be used, as well as special operators such as “ISNULL”, “:” and the like. A selected set of string, numeric, and Boolean functions can also be used to build the validation rules.

The transaction exchanger 110 can include a data enrichment module 235 in communication with the validation module 230. The data enrichment module 235 is configured to customize the validated normative transaction information to generate enriched normative transaction information. The data enrichment module 235 can be used by the user to add, modify or otherwise customize, in any suitable manner, the normative transaction information that has been validated by the validation module 230. For example, the data enrichment module 235 can be used to add the four digit add-on code (identifying a geographic segment within the five digit zip code delivery area) to a five-digit zip code or the like. The data enrichment module 235 does not alter the validated normative transaction information in such a way as to make the data unusable by or unshareable with other transaction exchangers 110. Rather, the data enrichment module 235 can be used to augment the validated normative transaction information to include additional (normative) information that can be shared with other transaction exchangers 110 and, ultimately, used by the (remote) client application devices 105.

The transaction exchanger 110 includes a message processing module 240 in communication with the data enrichment module 235. The message processing module 240 is configured to generate a transaction message by providing an envelope for the (validated and possibly enriched) normative transaction information in the common data format. Transaction information is encapsulated in a message, in particular, a transaction message. The message processing module 240 is further configured to execute predetermined next actions and processing demands that can be imposed by at least one other (remote) transaction exchanger 110 (e.g., to include information in the message that is expected by the (remote) transaction exchanger 110).

According to exemplary embodiments, a message is comprised of an envelope that contains blocks of information. The envelope has a small set of information including, for example, a unique ID for a message and certain other information that will permit the transaction exchanger 110 to process it. The blocks contain the various sets of information that comprise the message. One block type is the payload that contains the transaction information that is to be transmitted from an initiator to a target. Other blocks can contain information to support processing by the transaction exchanger 110, such as, for example, transmission, persistence, security and the like. For example, blocks can include information about the target's address, message security, and the like. Two exemplary blocks that can be used in a message are: 1.) the transaction routing slip that defines the path the message is to follow in the MOI as it goes from initiator to target; and 2.) the message processing history that keeps a running record of all state changes incurred by the message, for example, visiting an intermediate service, and the like. Thus, the envelope is a wrapper that is used to bundle the normative transaction information for transmission to other (remote) transaction exchangers 110 and the associated (remote) client application devices 105.

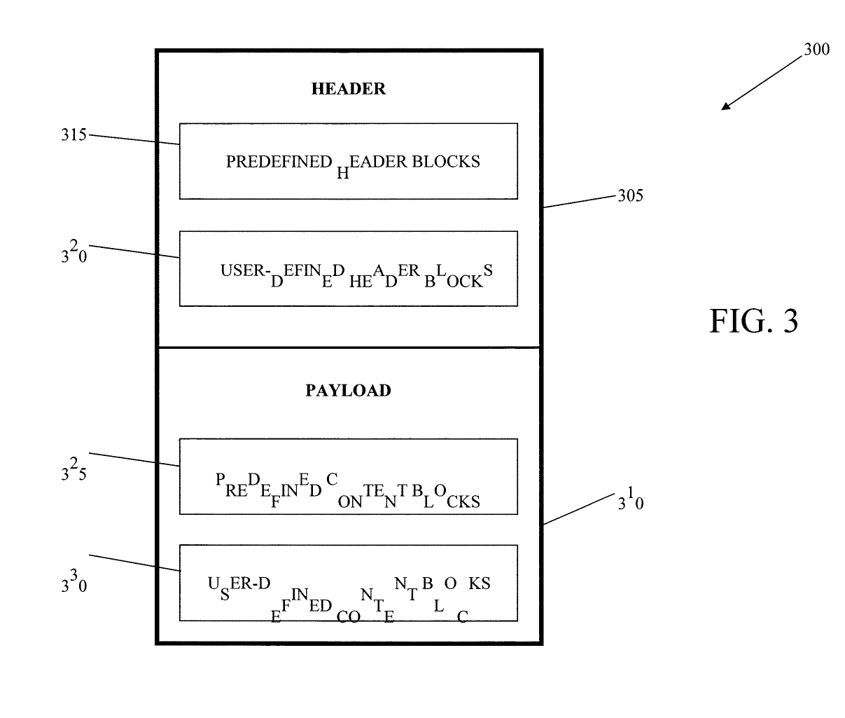

More particularly, FIG. 3 is a diagram illustrating a transaction message 300, in accordance with an exemplary embodiment of the present invention. The transaction message 300 comprises the message data 310 (payload or message content), message metadata 305 (header or message context), and, optionally, a message network header (e.g., as part of the message metadata 305). The message data 310 is comprised of instances of classes from the application domain model (i.e., the application map). The message data 310 can exist in a local data format (i.e., the data format used by the (local) client application device 105). The message data 310 can also be encrypted when sent over the network. The message metadata 305 is comprised of a set of user and system information that accompanies the message data 310. Some of the message metadata 305 can be supplied by the user (such as an addressee). Other data elements can be supplied by the transaction exchanger 110 through the message processing module 240, such as, for example, a unique message identifier, a timestamp, transaction context, and the like. Both users involved in a transaction (the local and remote client application devices 105) can view and otherwise use the metadata information. According to exemplary embodiments, the metadata information can be stored with the message data 310 in local data storage. The optional message network header can be comprised of a set of system-generated information that is used by the communications layer to properly deliver the message. The message network header is generally not visible or accessible to either users involved in a transaction, and does not have to be persistent. Some or all of the information in the message network header can be derived by the message processing module 240 from, for example, the message metadata 305.

According to an exemplary embodiment, each message can include a unique message identifier, generated by the message processing module 240 of the originating transaction exchanger 110. A message identifier can be guaranteed to be unique within the MOI. The message identifier generated by the message processing module 240 is independent of any message identifier generated by the communications infrastructure. According to an exemplary embodiment, the system 100 can support itinerary-based routing for messages. In other words, messages can be routed based on the business transaction definitions created by the users. These definitions can define the central services through which a message passes for a given message type and transaction type. When a message is instantiated, the itinerary is carried with the transaction message 300 in one of the header blocks of the message metadata 305 as the transaction message 300 travels through the system 100. For example, the itinerary can be declared as a linear sequence of transaction exchangers 110 through which the transaction message 300 passes until the transaction message 300 reaches its destination. The system 100 can also support content-based routing. In content-based routing, a transaction exchanger 110 can make decisions on where a message is to be routed based on the contents of the message. For example, the message processing module 240 can use message header-based routing, in which the message processing module 240 determines the next leg of the route based on information in a specific message header block.

The message processing module 240 is also responsible for processing the header blocks in the message envelope when a message is received from a network-facing queue listener. According to an exemplary embodiment, the message envelope can be an XML document comprised of blocks of data. Each block can include a corresponding class that processes the block. Blocks can be processed in a particular sequence, if desired. The message envelope structure and the processing of the blocks can be the same for all messages exchanged among members of the MOI. For example, a configuration file can define the association between each message header block and the class that processes the message header block.

As illustrated in FIG. 3, the transaction message 300 can include several types of blocks. For example, the message metadata 305 can include one or more predefined header blocks 315, which include header information that cannot be customized or extended by the user, and one or more user-defined header blocks 320, which include header information that can be customized and extended by the user. The message data 310 can include one or more predefined content blocks 325, which include message content that cannot be customized or extended by the user, and one or more user-defined content blocks 330, which include message content that can be customized or extended by the user. For example, the normative transaction information can be contained in the user-defined content blocks 330 of the transaction message 300. According to an exemplary embodiment, any block can be an indirect link (e.g., using XLINK/XPATH or the like). By using an indirect link, much of the content of a message need not be in the message itself. Such indirect links can be used, for example, for an often re-used routing slip, a very large payload that is actually a file to be FTP'ed, and the like.

the message metadata 305, Table 1 illustrates some of the types of information that can be included in the predefined header blocks 315 and the user-defined header blocks 320, although additional and/or alternative information can be included in the message metadata 305.

TABLE 1
Information in Predefined and User-Defined
Header Blocks 315 and 320

| | | Predefined or |
|---|---|---|
| Block | Description | User-Defined |
| Message | Uniquely identifies a message and its | Predefined |
| ID | context. Includes message type, message ID, | |
| | transaction ID, date/time created, message | |
| | category (from several defined, e.g., | |
| | business message, administrative message). | |
| Security | For message authentication and encryption. | Predefined |
| | Any message block can be signed and/or | |
| | encrypted, and the digests are added to | |
| | the Security block. | |
| Processing | Date/time sent/received. Each transaction | Predefined |
| History | exchanger 110 updates the history block as | and |
| | the message is processed, so messages | User-Defined |
| | contain a record of where they have been | |
| | and how they have been processed. The | |
| | history can be included in the message | |
| | acknowledgment which is returned to the | |
| | original sender. | |
| Message | Message processing flags determine | User-Defined |
| Processing | additional processing for a message, e.g., | |
| Flags | processing for potential duplicate | |
| | emission, non-repudiation, not-valid | |
| | warning, and the like. The classes for | |
| | these message processing flags are provided | |
| | by the user. | |
| Routing | Routing slip specifies the transaction | User-Defined |
| | exchanger 110 itinerary (e.g., addressing | |
| | and routing information), including central | |
| | services and the final recipient. The | |
| | itinerary is associated with the message | |
| | type and the transactions defined for it. | |
| | The routing slip should specify the entire | |
| | route and the reply-to address, but at a | |
| | minimum should specify the next step and | |
| | final destination. There can be arbitray | |
| | number of steps before reaching the final | |
| | destination. | |
| Custom | To handle other processing as needed. | User-Defined |

The message metadata 305 can include the message processing history for the transaction message. In other words, every time there is a change in the state of a transaction message 300, a history of that change can be stored in the message processing history. Such changes in state can include, for example, when a message is accepted by a transaction exchanger 110 from an Abstract Queue, when a message is sent to an Abstract Queue, when a message is transformed in any way, and the like. Message processing histories are used by the transaction exchanger 110 to understand the precise state of a transaction message 300 that it has received. The combination of the routing information and the message processing history provides information that can be used by the transaction exchanger 110 to understand what processing is required to accomplish the next step in the transaction. The message processing history can be comprised of individual information components (e.g., separate processing events), and the transaction exchanger 110 can be configured to process individual information components of the message processing history.

The message processing history can also include a history of the transaction to which the transaction information is directed. For example, a transaction can comprise a compound transaction, e.g., a multi-step transaction made up of simple (binary or one-step) transactions. By including the transaction history in the message processing history, exemplary embodiments of the present invention can suspend and resume a compound transaction as required by the business needs of the users. A compound transaction can be suspended until a predetermined condition is met. For example, the predetermined condition can be a time limit (e.g., the transaction is suspended until a certain amount of time has passed) or the like. The transaction can be resumed once the predetermined condition is satisfied. Additionally, by including the transaction history in the message processing history, users (both local and remote client application devices 105) can determine the status of individual components of the compound transaction and exchange the status information, as needed, for participating in, facilitating and/or completing the transaction. The system 100 can process or otherwise execute the individual components of the compound transaction either sequentially or in parallel.

The routing information contained of the envelope can define the high-level process flow of the transaction, such as the addressing and routing information for the transaction message 300. The routing information can specify the message itinerary (e.g., the transaction exchangers 110 through which the message will pass) and the acknowledgment behavior. According to an exemplary embodiment, the itinerary can be specified declaratively as a linear sequence of steps. For example, an itinerary can be specified as follows:

Step 1=“Send the message from {origin address} to {Service 1 address}”

Step 2=“Send the message from {Service 1 address} to {destination address}”

Step 3=“Send ACK from {destination address} to {origin address}”

It should be noted that the routing does not specify what occurs at each transaction exchanger 110. The behavior of each transaction exchanger 110 can be determined by the message processing module 240 and the first and second custom-processors 210 and 220 of each transaction exchanger 110, which, in turn, are based on the message type and other message metadata. The routing can support a linear process. Alternatively or additionally, the routing can support forks, joins, or conditional processing behavior. The end point of a given step is considered to be the starting point of the next step. Furthermore, the routing information can be changed by intermediate transaction exchangers 110 to allow for dynamic routing in which each transaction exchanger 110 can determine the next message hop.

Each block in the transaction message 300 can be encrypted using any suitable form of encryption. Descriptive information on the type of encryption of each block can be included in a block in the message metadata 305. By encrypting individual blocks, a transaction exchanger 110 or a module within the transaction exchanger 110 can read a header block containing information for it, while not being able to read the contents of a block of message data 310. Additionally, for a PKI-based encryption system, each block in the transaction message 300 can be individually, digitally signed. Digitally signing the blocks uniquely identifies the signer, incorporates a precise time and date stamp, and can guarantee that none of the content of the signed block has been changed or otherwise altered. Descriptive information of the digital signature of each block can be included in a block in the message metadata 305. The message processing module 240 can validate the signatures for any signed blocks in the transaction message 300. The message processing module 240 can also determine whether any encrypted blocks are intended for the current transaction exchanger 110, and if so, can be read. By default, signed/encrypted blocks that are not intended for a transaction exchanger 110 cannot be modified by that transaction exchanger 110. Conversely, blocks that are not signed or encrypted can be modified by any transaction exchanger 110. If a transaction exchanger 110 modifies a signed/encrypted block that is not intended for it, then the processing associated with that block can leave the original block and signature as is, make a copy of it, modify the copy, and sign the copy.

The transaction exchangers 110 include one or more communication modules 245 in communication with the message processing module 240. The communication modules 245 are configured to communicate the transaction message with at least one other (remote) transaction exchanger 110 for participating in, facilitating and/or completing the transaction. The communication modules 245 can be in communication with the communication modules of other transaction exchangers 110 using any suitable communication link 247 (e.g., either wired or wireless) and any suitable transmission protocol (e.g., TCP or other suitable network communication protocol). The communication modules 245 are also configured to receive transaction messages provided by the at least one other (remote) transaction exchanger 110 for participating in, facilitating and/or completing the transaction. As discussed below, the communication modules 245 are responsible for signing and encrypting a transaction message that is to be transmitted to another (remote) transaction exchanger 110. The communication modules 245 are also responsible for “finalizing” the transaction message before the transaction message is passed to the Abstract Queue for transmission. For example, the communication modules 245 can resolve references to the addresses of other transaction exchangers 110, including determining the address of the next destination. The communication module 245 is also configured to send message acknowledgments, if required.

The communication modules 245 are further configured to record transmitted and received transaction messages and the transaction states of the transmitted and received transaction messages. For example, the communication module 245 can notify the information queue module 205 (using any suitable type of signal or event notification) and the (local) client application device(s) 105 that a transaction message has been transmitted. Receipt of a transaction message by the communication module 245 can be the event or signal that begins processing of the transaction message by the transaction exchanger 110 for communication of the transaction information contained in the transaction message to the (local) client application device 105. Such processing of the received transaction message would be in a substantially reverse order to that which is performed for processing transaction information from the (local) client application device 105 to generate and transmit a transaction message.

It is noted that the flow of information and processing through the transaction exchanger 110 does not necessarily need to proceed forward and backward through the modules of the transaction exchanger 100 in the same sequence, nor does processing necessarily need to proceed in the order indicated for the modules of the transaction exchanger 110. For example, according to exemplary embodiments, one or more modules can be skipped or otherwise bypassed during processing, processing can cross back and forth through one or more modules (e.g., the validation module 230 may jump forward or backward and then restart the sequence), and processing can proceed in an order different than indicated in FIG. 2 (e.g., data enrichment performed by data enrichment module 235 may occur either before or after data validation performed by validation module 230).

With regard to security and encryption of communicated transaction messages, the transaction exchangers 110 are configured to support security standards such as, for example, Public Key Cryptography Standards (PKCS), suitable IETF standards (e.g., X.509 certificates, S-MIME, and the like), secure transport protocols (e.g., SSL and TLS), XML Encryption and XML Signature, conventional cryptographic algorithms, including encryption (e.g., RSA, 3-DES, and the like), digest (e.g., SHA, MD5, and the like), and message authentication codes (e.g., MAC, HMAC and the like), and other like security standards. The transaction exchangers 110 are also configured to support message authentication and encryption from a level of no security (e.g., if using leased lines or working with low-value messages), to self-signed certificates, to public key infrastructure (PKI). However, the system 100 does not impose a security model on the users. Rather, the users can choose to use any of these or other security models, or none at all. However, once a model is chosen, all transaction exchangers 110 should comply with that security model.

For message authentication and encryption, the system 100 can support several models for authenticating/encrypting messages, including, for example, self-signed X.509 certificates and PKI. By default, the system 100 can use self-signed certificates for performing authentication and encryption. The self-signed certificates model is similar to the PKI model, except that there is no trusted third party (e.g., a certificate authority (CA)) that validates the certificates. A sender creates the private key and the certificate with which the corresponding public key is broadcast, but the identity of the sender is not verified by a third party. Such a model implies that there is some level of trust between parties that is established outside of the CA. For example, the parties might communicate via a secure leased line, or validate certificates out-of-band (e.g., through e-mail or the Web).

In contrast, a PKI binds public keys to entities, enables other entities to verify public key bindings, and provides the services needed for ongoing management of keys in a distributed system. PKI ensures that the entity identified as sending the transaction is actually the originator, that the entity receiving the transaction is the intended recipient, and that data integrity has not been compromised. A certificate binds an identity (Distinguished Name or DN) to a public key. Information encrypted with the public key can only be decrypted with its corresponding private key, and vice versa. Under the PKI model, the sender's transaction exchanger 110 would require a private key, held securely locally with the transaction exchanger 110, and a certificate with which the corresponding public key is broadcast. The key pair can be generated while creating a certificate application, which, when completed, is sent to the CA associated with the local user. It is the responsibility of the CA to verify the applicant's identity, to maintain a Certificate Revocation List (CRL) and to publish a list of valid certificates by Distinguished Name (DN). When the CA has satisfied its verification requirements, the certificate is sent to the transaction exchanger 110 and added to the list of valid certificates maintained by the transaction exchanger 110.

The list of valid message recipients for a given transaction exchanger 110 can be maintained and published by the CA associated with the (local) user. The transaction exchanger 110 can maintain a cached copy of such a list. Before each time the list is used, the transaction exchanger 110 can ensure, via a suitable communication link with the CA, that the list is up-to-date. The list can be made available to the (local) client application device 105, via the transaction exchanger 110, for presentation to the user while selecting the message recipient.

The decision about which message blocks, if any, to sign or encrypt and under what conditions is controlled by the users. More particularly, such information can be part of the envelope definition that is distributed to all members of the MOI. For each envelope block, the signing/encryption can be specified as being either mandatory, optional or not allowed. Signing data includes encrypting the data digest with a private key associated with a certificate. The transaction exchangers 110 can be configured to support the ability to sign only a portion of the data in a message. For example, particular blocks of data in an XML message (e.g., header blocks or payload blocks) can be signed. The standard security processing generally prohibits a signed message block from being changed by any intermediate transaction exchanger 110. However, if it is necessary for an intermediate transaction exchanger 110 to change signed message blocks, a copy of the original message block can be included in the message (along with its signature), then changes can be made to the copy and the copy signed.

Encrypting data generally includes the generation of a symmetric key, encrypting the message data with that key, and then encrypting the key with the public key of the intended recipient. As with signatures, the transaction exchangers 110 can be configured to support the ability to encrypt specific blocks of data in an XML message. However, the security block of a message will not be encrypted.

According to exemplary embodiments, certain processing occurs before a secure message is transmitted. Such processing can be performed by the communication modules 245, and can include the following, for example: acquire the certificate for the sender; look up the certificate for the recipient; validate the certificate; sign the transaction message or selected parts thereof; and encrypt the transaction message or selected parts thereof. Additional and/or alternative steps can also be performed by the communication modules 245 and/or the message processing module 240.

According to exemplary embodiments, if a received transaction message (or parts thereof) has been signed or encrypted, the message processing module 240 or the communication modules 245 can process the transaction message in, for example, the following manner after the transaction message is passed from the associated queue listener: extract the certificate from the transaction message; validate the received certificate; validate the transaction message signature; and if encrypted, decrypt the transaction message or the encrypted parts thereof. The various modules of the transaction exchanger 110 can then process the decrypted transaction message to pass the transaction information to the (local) client application device 105.

Each transaction exchanger 110 can include a keystore that is configured to store the private key of the sender, as well as certificates for other (remote) transaction exchangers 110 with which the (local) transaction exchanger 110 can communicate. Such a keystore can be kept up-to-date to reflect additions/deletions of participants from the list of possible message recipients, and to reflect changes to individual certificates (e.g., when a certificate expires). The keystore can be maintained and accessed differently, depending on whether the MOI is using self-signed certificates or PKI.

When a new transaction exchanger 110 joins the MOI of system 100, the certificate for the new transaction exchanger 110 is distributed to all participants who are allowed to exchange messages with the new transaction exchanger 110. The keystores of those participants are then be updated with the new certificate. In the self-signed certificates model, the transaction exchangers 110 can create the certificates and have the certificates distributed to all the other participating transaction exchangers 110 (e.g., through a centralized distribution facility) so that the keystores of those transaction exchangers 110 can be updated. In the PKI model, the CA is the trusted third party responsible for vetting and confirming the identities of the transaction exchangers 110. The CA can provide a central location for certificate storage and distribution.

As discussed previously, the transaction exchangers 110 use the Abstract Queues to send and receive messages. According to an exemplary embodiment, the Abstract Queues can be responsible for message transport security. For example, if a JMS message broker using SSL is used, then such a transport security mechanism is abstracted from the transaction exchanger 110 processing, given the nature of the Abstract Queues. Thus, the transaction exchanger 110 simply places a message on the Abstract Queue, and the Abstract Queue will perform all necessary subsequent processing to ensure the message transport security.

The system 100 is also configured to support non-repudiation of delivery for transaction messages. Non-repudiation of delivery provides proof that the recipient received a transaction message, and that the recipient recognized the content of the transaction message (e.g., the message could be understood by the receiving transaction exchanger 110, although this does not necessarily imply that the transaction message could be understood/consumed by the (remote) client application device 105). The security model for the transaction exchangers 110 can use self-signed X.509 certificates or the like to achieve non-repudiation, which does not involve the services of a CA. Such a model can provide a base level of non-repudiation of delivery. If a trusted third party is required for an additional level of security, the transaction exchangers 110 can be enabled and configured for PKI security, which requires a CA. Whichever level is selected, non-repudiation can be provided without using a central service. In such a scenario, non-repudiation can be provided by the combination of digital signatures and timestamps included on transactions messages. With the addition of PKI, such signatures are vetted by the certificate chain that includes a trusted root (the CA).

However, a central service can be added, where transaction messages marked for non-repudiation can automatically pass and be recorded in a central archive. Such a scenario can add some amount of processing overhead, but also offers a non-repudiation resolution service in which all records are easily accessible, storage can be rigorously controlled, and the like. Alternatively, such functionality can be provided without using a central service. However, if the storage of transaction messages is scattered over a number of member repositories, some of which might have archived messages to offline storage, collecting the records required to prove non-repudiation may become somewhat more challenging.

The transaction exchanger 110 includes a repository or data storage module 250 in communication with the transaction exchanger 110. The data storage module is configured to store information transmitted and received by the transaction exchanger 110, and any other information maintained by the transaction exchanger 110. For example, the data storage module 250 can be used to enable reporting on the state of any transaction message. For example, when a transaction message is transmitted, the communication modules 245 can store the transaction message in the data storage module 250 after final processing of the transaction message is completed and before placing the transaction message on the appropriate Abstract Queue. When a transaction message is received, the appropriate queue listener can store the transaction message in the data storage module 250 before processing of the message begins. The information queue module 205 can update the message (e.g., the status of the message) before the associated transaction information is communicated to the (local) client application device 105. The database storage module 250 can comprise any suitable type of computer database or computer storage device that is capable of storing data. However, the structure of the database storage module 250 can be based on the object model, which is the normative data model that is used by all members of the MOI of system 100.

The data storage module 250 can also contain the information necessary for the transaction exchanger 110 to operate. However, each of these local data storage modules 250 is, in aggregate, an integral part of the BTA, as the data storage modules 250 are where the data for the BTA can be stored. While the information in the data storage modules 250 can be accessible and of interest to the (local) client application device 105 being serviced by the transaction exchanger 110, the format and schema of the data storage module 250 can be defined in the process of creating a BTA.

Other types of information that can be maintained in the data storage module 250 include the message and payload states. The data storage module 250 can persist message and payload states until the transaction with which they are associated is complete. The state of a transaction message can change as a result of, for example, processing by the transaction exchanger 110. For example, the receipt of a transaction message by the receiving transaction exchanger 110 can trigger an acknowledgement to the sending transaction exchanger 110. Such an acknowledgement can be associated with the sent transaction message, and result in a change in the reported state of the (received) transaction message. Queries of the data storage module 250 can provide reports on the state of transaction messages and transactions that have been processed by a transaction exchanger 110. The message and payload information persisted in the data storage module 250 can be retained until such information is explicitly removed. However, the data storage module 250 is both a cache and a persistence mechanism, handling the ever-changing stream of information being processed by the transaction exchanger 110, as opposed to a more traditional database, which stores information permanently for later retrieval.

The data storage module 250 can also hold any or all metadata needed by a transaction exchanger 110, such as the XML schemas associated with message payloads, the maps used to transform messages, and the like. Additionally, since the data storage modules 250 associated with each transaction exchanger 110 can provide data storage in the aggregate for a BTA, the data storage modules 150 can also be used to store other information in addition to persisted transaction messages. In particular, such additional information can include a wide variety of setting and configuration files. Also, the data storage modules 250 can contain information that can be used to monitor activity of a local transaction exchanger 110 or to monitor the BTA as a whole.

The data storage modules 250 are further configured to support “DataFrame” functionality. The DataFrame provides a mechanism for cutting and/or copying datasets from the data storage module 250 and preserving these datasets as, for example, a large XML document or other like data format. The transaction exchangers 110 can access such DataFrames using the same interface used to read data from the data storage modules 250. Additionally, import capabilities allow information within the DataFrame to be imported into the data storage module 250. For example, DataFrames can be used for secondary back-up and restore. The primary back-up can rely on the conventional back-up capabilities of the database used by the data storage module 250. The DataFrames can also be used for secure archiving. Such a feature involves cutting data from the data storage module 250, signing the “cut” data and storing such signed data as an XML document. The archived data can be read (by those that have permission) at anytime without the need for any special program.

The DataFrames can further be used for bulk transmission of information stored in the data storage module 250. For example, any query into the data storage module 250 can become a DataFrame that can then be sent as the payload in a transaction message to another member in the MOI or sent externally as an XML document. The DataFrames can be used for the transmission of metadata sets. Metadata can be expressed in XML documents and stored. The distribution of metadata can be accomplished by creating appropriate DataFrames of such metadata for distribution to and processing by the transaction exchangers 110. The DataFrames can also be used for signed, complete self-contained messages. In certain situations, it may become necessary to send a self-describing, self-contained transaction message with all of the information relevant to that transaction message including, for example, the original version of the message, any local transformations, the XML schema defining the payload, message history, and the like. All such information can be captured as a DataFrame, signed for robust non-repudiation, and sent as the payload of a transaction message. The DataFrame functionality can be used for other processing in conjunction with the data storage module 250.

The security of the data storage module 250 can be performed using the trusted database account principle. Such a principle means that a fixed user account is used to access the data stored in the data storage module 250, but the user will not be able to manipulate or access the database directly. The transaction exchanger 110 can access the database using a user ID and password that can be encrypted and stored within a local configuration file stored in the transaction exchanger 110. The user ID and password can be generated by the installer when the transaction exchanger 110 is installed for the first time.

The transaction messages stored in the data storage module 250 do not need to be encrypted. However, the transactions messages can be encoded. Such encoding allows any Unicode characters to reside in the transaction message body without restrictions. For example, Base64 encoding can be used, although any suitable encoding scheme can be used. A signature can be stored together with each transaction message in the data storage module 250 to ensure data integrity. The signature can include a digest of the transaction message (such as a CRC, MD5 or the like), and be encrypted with the private installation key. The private installation key can be generated when the transaction exchanger 110 is installed for the first time, on a per installation basis, and stored securely. The generated key can be encrypted with a static private key internal to the transaction exchanger 110, and stored in several locations, such as, for example, a special table in the data storage module 250, a settings file and the like. The transaction exchanger 110 can check the signature each time the transaction exchanger 110 opens a transaction message from the data storage module 250. If the transaction message was tampered with, the transaction exchanger can log an entry in a log file and cancel the opening of the transaction message in question.

Any or all information contained in the data storage module 250 can be archived at any suitable time. The data in an archive can comprise one (perhaps large) XML file (or other suitable data format) containing all or substantially all of the archived transaction messages, and any relevant records used by those transaction messages. Both transaction messages and data can be Base64 encoded or the like. Although the data in the archive can be encrypted, there is no requirement to do so. Once the archive file is created, a checksum can be computed using, for example, the SHA algorithm or other suitable checksum algorithm. The archived data file and the digest can then be compressed together in, for example, a ZIP file or the like for storage or for transmission to another site, for example, for offsite storage. When the archived data file is loaded, the digest of the archived data file can be calculated and compared with the decrypted checksum stored in the ZIP file. If the two do not match, the restore operation can be aborted, and the appropriate security violation logs can be written.

Referring to FIG. 1, the system 100 can include a transaction administrator 115. The transaction administrator 115 can be in communication with each or any of the transaction exchangers 110 in the system 110. The transaction administrator 115 can be used to measure and maintain the transaction exchangers 110. The transaction administrator 115 can also be used to monitor any suitable statistics of the transaction exchangers 110 (e.g., number of messages sent and received by each transaction exchanger 110, errors, disk reads/writes from/to data storage modules 250, and the like). Any suitable number of transaction administrators 115 can be used in the system 100 to maintain and monitor the transaction exchangers 110. According to an exemplary embodiment, the transaction administrator 115 can be comprised of a transaction exchanger 110 with the administrative capabilities to configure, measure, monitor, maintain and otherwise govern the other transaction exchangers 110 in the system 100.

The transaction administrator 115 can be configured to administer and update each transaction exchanger 110 via automated administrative messages, a process referred to herein as “injection.” Thus, the transaction administrator 115 can distribute updates to each or any transaction exchanger 110 using suitable administrative messages. The administrative messages can be of the same structure as the transaction messages, such as the structure of transaction message 300 illustrated in FIG. 3. Any suitable feature of the transaction exchangers 110 can be updated independently through injection, including, for example, the object model, the XML model, the mapping between the object model and XML model, business transaction definitions, global validation rules, envelope processing configuration, Abstract Queue implementations, local processing action lists and associated classes, formatter maps (includes local validation), configuration files, map and configuration file structures, and the like.

In addition, any custom processing performed in the transaction exchangers 110 (e.g., via the first and second custom-processor modules 210 and 220) can be updated using appropriate administrative message sent from the transaction administrator 115. For example, the administrative messages, like the transaction messages, can provide a definable block in the envelope of the administrative message that is configured to provide parameters for the customized processes. The features of the transaction exchangers 110 can be updated using suitably-encrypted secure administrative messages. In other words, the administrative message are configured to utilize message security in a manner similar to that used in the transaction messages (e.g., individual blocks can be encrypted and signed, and the like). Additionally, the transaction administrator 115 can be configured to query one or more transaction exchangers 110 to ascertain the status of a transaction, using the unique transaction ID tags, envelope ID tags, message ID tags or other identifying information contained in a transaction message. The administrative messages used by the transaction administrator 115 can also be used to query any data stored in any data storage module 250 associated with any transaction exchanger 110.

The transaction exchangers 110 include processing that can ensure reliability in case of failure. The transaction exchanger 110 can achieve such reliability by using checkpoints at various points of the process between the modules of the transaction exchanger 110. A checkpoint is a transactional boundary that can verify that the message is ready for the next (processing) step. A checkpoint can send a signal to the prior checkpoint indicating that the message was successfully processed. The prior checkpoint can then remove that message from whatever storage mechanism was used. If an error condition occurs along the way to the next checkpoint, or a timeout occurs and the message never reaches it, the whole transaction is rolled back to the state of the message as it existed at the prior checkpoint. Checkpoints can exist anywhere along the process, between any modules used by the transaction exchanger 110.

For example, a checkpoint can be located in the information queue module 205 at the interface to the client application device 105. A failure that occurs before this point can be handled by the Abstract Queue used to communicate with the client application device 105. For a transmitted message, a checkpoint can be located at the output of the communication module 245. Failure before this point can roll the message back to the state it was in at the checkpoint for the information queue module 205. Once the transaction message passes the checkpoint at the communication module 245, the transaction message can be stored in the data storage module 250. For received transaction messages, failure before this point can roll the message back to the state it was in at the checkpoint at the output of the communication module 245 of the sending transaction exchanger 110, that is, to the state of the message when it was sent (which is persisted in the data storage module 250 of the sending transaction exchanger 110). If the transaction message is received correctly, processed, but fails at the checkpoint for the information queue module 205 (i.e., before the transaction information is passed to the client application device 105), the message can be rolled back to the state it was in when received (i.e., at the checkpoint of the communication module 245). It should be noted that when a transaction message is passed to an error queue, the transaction is considered to be complete.

According to exemplary embodiments, the universe of message exchanges that can be used in a BTA is defined by business transactions that can be described utilizing activity diagrams. (An activity diagram is graphic way of describing the interaction between objects or processes.) In the case of a business transaction, the activity diagram can describe the interaction between transaction exchangers 110. Each business transaction starts by an initiator client application device 105 placing a message (transaction information) on a queue. The message is processed by the transaction exchanger 110 and then placed on the Abstract Queue associated with the communication module 245 to be picked up by one or more target transaction exchangers 110 for use by the (remote) client application device 105.

One difference between the BTAs supported by the system 100 and the business transactions supported by more general BTMs and workflow tools is that nested transactions are not used by the system 100. The reason for this is that a compound transaction can be suspended with all its states and then resumed, as discussed previously. Such a mechanism renders nested transactions unnecessary. Such a capability can keep transactions smaller and simpler, and can allow a more arbitrary and dynamic aggregation of basic transactions.

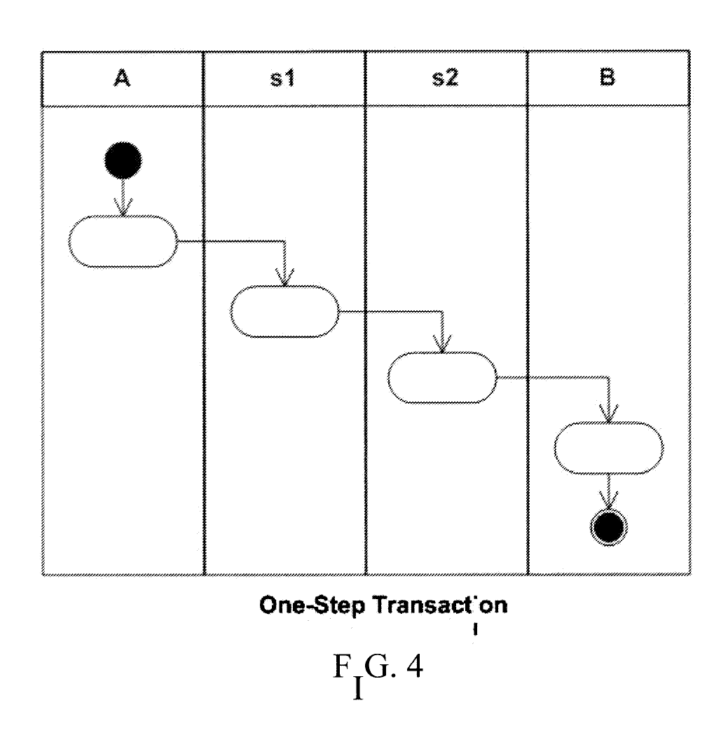

The set of business transactions supported in a BTA according to exemplary embodiments can be expressed through stylized UML activity diagrams. The business transaction definition determines the entire route of a message. It can be visualized as an activity diagram showing either a one-step transaction or a request/response. FIG. 4 illustrates a one-step transaction using an activity diagram, in accordance with an exemplary embodiment of the present invention. In FIG. 4, a message exchange occurs from A to B that passes through two central services, s1 and s2. When A initiates the message, the business transaction definition specifies a central service transaction exchanger 110, s1, as the next destination. For example, the next destination can be a credit check service, an audit repository, or the like. The service is specified generically, and it is up to the transaction exchanger 110 to resolve the actual endpoint address of the service before the message is sent. The business transaction definition used for a particular message and transaction type can be the same at all transaction exchangers 110. Such commonality makes it possible to resolve addresses in two ways: 1.) the initiator can determine all of the addresses at the outset and specify them within the routing block of the message header; or 2.) each transaction exchanger 110 can specify the address of the next transaction exchanger 110. As discussed previously, the address resolution is performed by the communication module 245.

According to exemplary embodiments, a message acknowledgment, referred to herein as a “business acknowledgment,” is an administrative message sent from one transaction exchanger 110 to another transaction exchanger 110 indicating positive receipt of a transaction message. It should be noted that negative acknowledgments are always sent if there is a delivery failure or other error. A business acknowledgment can contain any suitable type of acknowledgment information about the original message, such as, for example: the message ID block, which provides unambiguous identifying information about the message; and the history block, which includes a record of each transaction exchanger 110 where the message has previously stopped. The business transaction definition can specify the business acknowledgment behavior. There should be at least one business acknowledgment in a business transaction definition. When a transaction message reaches a destination on its itinerary, the business transaction definition can specify one or more transaction exchangers 110 that should receive a business acknowledgment. The transaction exchangers 110 that were part of the message's route can be sent a business acknowledgment.

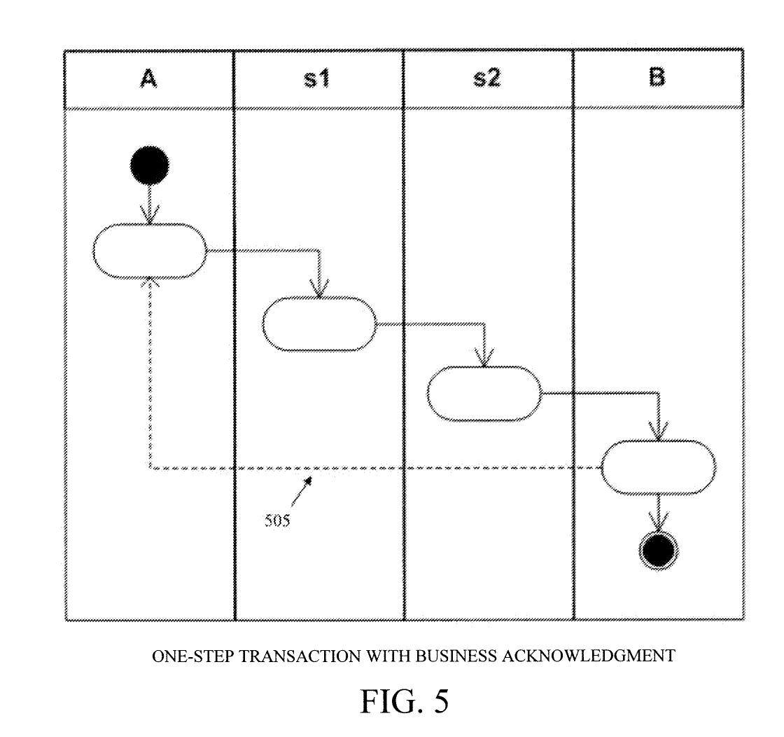

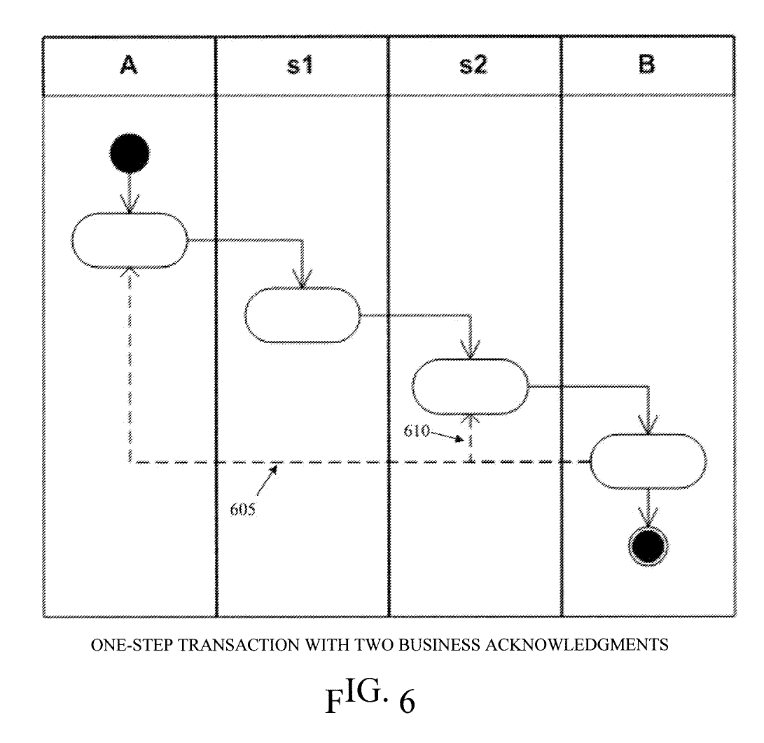

FIG. 5 illustrates a one-step transaction with a business acknowledgment, using an activity diagram, in accordance with an exemplary embodiment of the present invention. In FIG. 5, a one-step transaction from transaction exchanger A to transaction exchanger B occurs. Once the transaction message is (successfully) received at transaction exchanger B, a business acknowledgment 505 is sent from the destination (B) to the origin (A). FIG. 6 illustrates a one-step transaction with two business acknowledgments, using an activity diagram, in accordance with an exemplary embodiment of the present invention. In FIG. 6, a one-step transaction again occurs from transaction exchanger A to transaction exchanger B. However, the destination (B) now sends two business acknowledgments, one (610) to s2 and another (605) to the origin (A). In FIG. 6, transaction exchanger B sends both business acknowledgments; s2 does not send the business acknowledgment to transaction exchanger A.

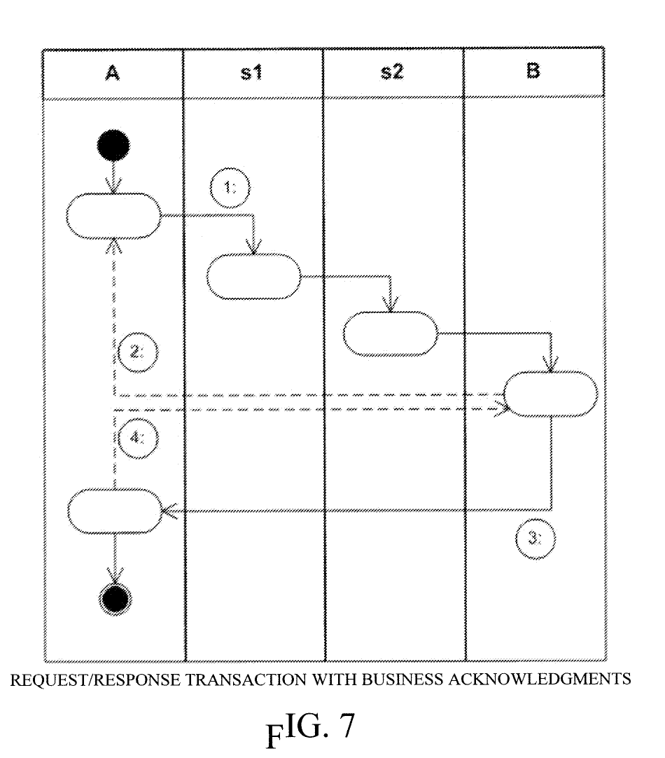

FIG. 7 illustrates a request/response transaction, using an activity diagram, in accordance with an exemplary embodiment of the present invention. Request/reply transactions are defined where the information in the request transaction message is, in effect, a query and the information in the response transaction message provides the answer to that query. It should be noted that the response transaction message must return to the initiating client application device 105, but does not necessarily have to pass through the same transaction exchangers 110 as the request transaction message. Request/reply transactions are defined where the information in the request transaction message is, in effect, a query and the information in the response transaction message provides the answer to that query. It should be noted that the response transaction message must return to the initiating client application device 105, but does not necessarily have to pass through the same transaction exchangers 110 as the request transaction message. In FIG. 7, transaction exchanger A sends a request to transaction exchanger B (step 1). Transaction exchanger B sends a business acknowledgment to transaction exchanger A to acknowledge the request (step 2). Transaction exchanger B then sends the reply to transaction exchanger A (step 3). Transaction exchanger A then sends a business acknowledgment to transaction exchanger B to acknowledge the reply (step 4). Many such business transaction, both one-step and multi-step, can be specified using such activity diagrams.

Each of components of the system 100, including the transaction exchangers 110 and transaction administrator 115, and each of the modules of the transaction exchanger 110, including the information queue module 205, the first custom-processor module 210, the formatter module 215, the second custom-processor module 220, the mapping module 225, the validation module 230, the data enrichment module 235, the message processing module 240, the communication modules 245 and the data storage module 250, or any combination thereof, can be comprised of any suitable type of electrical or electronic component or device that is capable of performing the functions associated with the respective element. According to such an exemplary embodiment, each component or device can be in communication with another component or device using any appropriate type of electrical connection that is capable of carrying electrical information. Alternatively, each of the components of the system 100 and the modules of the transaction exchangers 110 and transaction administrator 115 can be comprised of any combination of hardware, firmware and software that is capable of performing the function associated with the respective component or module.

Alternatively, the transaction exchangers 110 and transaction administrator 115 can each be comprised of a microprocessor and associated memory that stores the steps of a computer program to perform the functions of the modules of the respective components. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming. For example, the actual source code or object code of the computer program can be stored in the memory.

In addition, the communication links between the transaction exchangers 110 and between the transaction exchangers 110 and transaction administrator 115 can be comprised of any suitable type of communication medium or channel (e.g., either wired or wireless) capable of transmitting and receiving electrical information. Furthermore, as illustrated in FIG. 1, each of the client application devices 105 can be comprised of a suitable user application (e.g., a software application) that is either separate from (e.g., first, second and third client application devices 105) or integral with (e.g., Mth client application device 105) the associated transaction exchanger 110. The system 100 can include a graphical user interface. The graphical user interface can be configured to provide access to and management of the transaction exchangers 110, for example, using the transaction administrator 115.

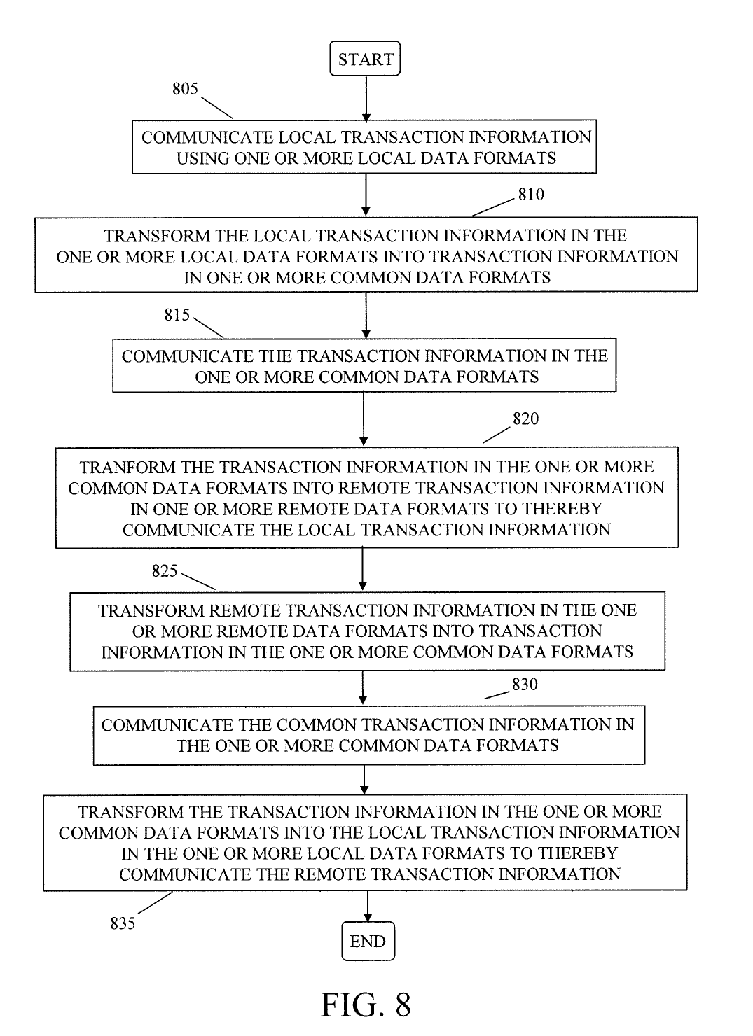

FIG. 8 is a flowchart illustrating steps for communicating information associated with a transaction, in accordance with an exemplary embodiment of the present invention. In step 805, local transaction information is communicated using one or more local data formats. In step 810, the local transaction information in the one or more local data formats is transformed into transaction information in one or more common data formats. In step 815, the transaction information in the one or more common data formats is communicated. In step 820, the transaction information in the one or more common data formats is transformed into remote transaction information in one or more remote data formats to thereby communicate the local transaction information. In step 825, the remote transaction information in the one or more remote data formats is transformed into the transaction information in the one or more common data formats. In step 830, the transaction information in the one or more common data formats is communicated. In step 835, the transaction information in the one or more common data formats is transformed into the local transaction information in the one or more local data formats to thereby communicate the remote transaction information.

According to an exemplary embodiment, the transaction can comprise a compound transaction. For example, the compound transaction can be suspended until a predetermined condition is satisfied. The predetermined condition can comprise, for example, a time limit or other suitable predetermined condition. The status of a component of the compound transaction can be determined and/or exchanged. The one or more common data formats can include information configured to allow apprehension of the transaction. The transaction can also be administered, for example, using automated messages. The transaction information in the one or more common data formats can include, for example, at least one of unique transaction ID tags, envelope ID tags, and message ID tags. The status of the transaction can be ascertained based on the at least one of the unique transaction ID tags, envelope ID tags and message ID tags.

According to an exemplary embodiment, the local transaction information, transaction information in the one or more common data formats, and the remote transaction information can be aggregated to form a fully distributed data store, which can be queried or otherwise accessed to obtain information from the data store. A standardized XML document can be generated from at least one of the local transaction information, the transaction information in the one or more common data formats and the remote transaction information. The standardized XML document can be associated with a transaction. For example, two or more standardized XML documents can be combined into one standardized XML document that is used for non-repudiation of a business transaction.

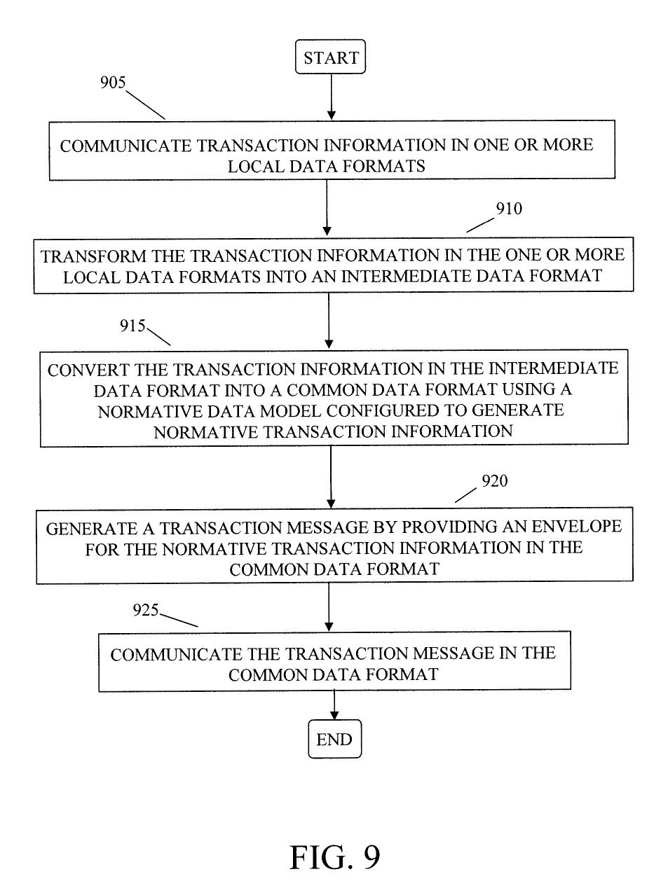

FIG. 9 is a flowchart illustrating steps for communicating information, in accordance with an alternative exemplary embodiment of the present invention. In step 905, transaction information is communicated in one or more local data formats. In step 910, the transaction information in the one or more local data formats is transformed into an intermediate data format. In step 915, the transaction information in the intermediate data format is converted into a common data format using a normative data model configured to generate normative transaction information. In step 920, a transaction message is generated by providing an envelope for the normative transaction information in the common data format. In step 925, the transaction message in the common data format is communicated.

According to an exemplary embodiment, the transaction information in the intermediate data format can be transformed into the one or more local data formats. The normative transaction information in the common data format can be converted into the intermediate data format. The envelope for the normative transaction information in the common data format can be processed. The transaction message can also be received. The transaction information can be processed using the one or more local data formats. The intermediate data format can comprise, for example, HTML, XHTML or XML or the like (i.e., isomorphic XML). The transformed transaction information can be processed using the intermediate data format. The normative transaction information can be validated. For example, the normative transaction information can be validated to ensure that the normative transaction information includes data required by mandatory data fields, cross-data field constraints and the like. The validated normative transaction information can also be customized to generate enriched normative transaction information.

According to an exemplary embodiment, transmitted transaction messages and transaction states of the transmitted transaction messages can be stored. Received transaction messages and transaction states of received transaction messages can also be stored. A notification can be generated that a transaction message has been transmitted or received. One or more blocks of normative transaction information can be encrypted. The envelope can be configured to provide descriptive information of the encryption. Additionally or alternatively, the one or more blocks of normative transaction information can be digitally signed. The envelope can be configured to provide descriptive information of the digital signature. The envelope of the normative transaction information can include message processing history for the transaction message. The message processing history can include information components. For example, individual information components of the message processing history can be processed. The message processing history can also include a record of a change in state of the transaction message. The envelope of the normative transaction information can include addressing and routing information for the transaction message. The envelope of the normative transaction information can also include transaction history of the transaction.

Exemplary embodiments of the present invention are configured to facilitate the automatic initiation, processing and completion of a transaction. Any suitable type of transaction that can be performed electronically using one or more steps can be supported by the system 100. For example, the transaction can be one or more of a commercial transaction, a legal transaction, a financial transaction, a governmental transaction, a medical transaction, a civic transaction, a social transaction, or other suitable transaction. In other words, the transaction can be associated with one or more or a banking industry, a trading/securities/financial industry, a healthcare industry, a telecommunication industry, a satellite service industry, an energy industry, a utility industry, a manufacturing industry, an automotive industry, a pharmaceutical industry or other like industry. Several examples of application of the system 100 to various types of transaction for various types of industries will be discussed.

A. Banking

Assume that the Treasury Systems division within a bank wishes to receive automatic payment transactions from their corporate customers. The bank has a specific back-end application format that they desire for all transactions received. The bank also has certain data content, data validation, and other rules to which the bank desires that each automatic transaction conform. Each customer has application systems that utilize a format or formats different than that desired by the bank. Exemplary embodiments of the present invention can allow such disparate application systems (between the bank and the bank's customers) to automatically exchange payments without modification to either the bank's or the customers' applications.

The bank begins by configuring a transaction exchanger 110 to include the content requirements of each desired payment transaction. The bank defines the normative data model, data validation rules, security requirements and rules, custom processes, data enrichment processes, routing rules, error handling processes, and other pertinent processes. The bank then configures a copy of the transaction exchanger 110 to operate within the bank, whereby each valid transaction received from another copy of the transaction exchanger 110 is translated from normative information into the bank's desired format for its back-office processing by the bank's client application device 105.

The bank then configures a copy of the transaction exchanger 110 at the site of each corporate customer from whom they desire to receive automatic payment transactions. The transaction exchanger 110 is configured to operate with each customer's local application(s) (i.e., the client application devices 105). The transaction exchanger 110 processes payments from the format used by that customer's client application device 105 into the format (non-normative information) used by the customer's version of the transaction exchanger 110. The customer's version of the transaction exchanger 110 then validates, enriches, secures, records, logs the data according to the processes and/or rules established by the bank, returning errors to the customer as configured, and then sends successful payment transaction messages, in normative form, to the bank. The transaction messages are received by the transaction exchanger 110 located at the bank, checked against all content and validation rules, then processed from normative form into the format used by the bank's transaction exchanger 110, logged, confirmed and processed into the transaction information used by the bank's back-office application. Automated payment transactions can then flow from the transaction exchangers 110 located at customer sites to the transaction exchanger 110 located at the bank site—flowing payments from customer applications to the bank's back-office application, without modification to either the bank's or the customers' applications.

B. Trading Exchanges

Assume that a group of companies or an independent Service Provider wishes to create a closed-end trading network between selective buyers and sellers of a particular commodity, avoiding certain issues that they have on public trading forums such as the New York Mercantile Exchange (NYME). Such a service requires specific formats to be interchanged between participating companies. However, each buyer and seller currently has existing application systems that utilize different formats for analyzing and registering trades. The trading closed-end network cannot succeed unless these disparate systems can be linked. Exemplary embodiments of the present invention can allow such disparate application systems (between the buyers and the sellers) to automatically exchange the data required for successful commodity trading without modification to any potential counter-party's applications.

Exemplary embodiments can allow the Service Provider to determine the requirements of the transactions that will be processed (e.g., a format could be a simple trade of a fixed amount, at a fixed time, at a fixed price, or it could be a complex structure in which the amounts, timing of receipt of amount, price paid for each amount received, and credit/payment instructions vary). The Service Provider defines the types of transactions (e.g., bid, offer, execute). The Service Provider also defines data content, data validation, and other rules to which each transaction must conform (e.g., how anonymity is protected during the trading process, how to bill for the use of the system, and the like). The Service Provider begins by configuring a transaction exchanger 110 to include the content and processing requirements of each desired transaction. The Service Provider then defines the normative data model, data validation rules, security requirements and rules, custom processes, data enrichment processes, routing rules, error handling processes, administrative messages and rules, and other pertinent processes. The Service Provider then configures a copy of the transaction exchanger 110 so that the transaction exchanger 110 can receive valid transaction messages from another copy of the transaction exchanger 110.

The Service Provider then configures a copy of the transaction exchanger 110 at the site of each buyer and seller with whom they desire to be participants in the closed trading network. Each of these transaction exchangers 110 is configured to operate with that particular customer's local application(s) (i.e., the client application devices 105). The transaction exchanger 110 is also configured to interact with all other transaction exchangers 110 within the closed network, through the passing of normative information in the form of transaction messages. Each transaction exchanger 110 can process information in the format of that participant's local client application device 105 into the format used by that participant's version of the transaction exchanger 110. The participant's version of the transaction exchanger 110 then validates, enriches, secures, records, logs the data according to the processes and/or rules established by the service provider as well as rules and processes that the customer themselves can establish (e.g., what specific trading parties to whom a particular type or amount of transaction will be routed, details on the payment of the transaction), returning errors to the customer as configured, and then sending successful commodity trading transaction messages, in normative form, to another participant. The transaction messages are received by the transaction exchanger 110 located at the other participant's site, checked against all content and validation rules, then processed from normative form into the format used by that participant's transaction exchanger 110, logged, confirmed and then processed into the transaction information used by the participant's (local) application. Accordingly, automated bids and purchases of the commodity can then flow from the transaction exchangers 110 located at each participant's site to the transaction exchangers 110 located at other participants' sites—flowing trades from each participant's application to other participants' applications, without modification. A similar scenario can be used by a Service Provider who wishes to create a private closed-end trading network between buyers and sellers of a security, a derivative of a security, or some other financial instrument.

C. Utilities

The smooth supply of electricity relies on many different enterprises, such as, for example, generation suppliers, utilities that supply/manage the distribution of electricity, and transmission entities that are responsible for the transport of electricity. For a particular region, there is an Independent Service Operator (ISO) that is assigned the responsibility that all of these entities work together. Such collaboration involves the real-time exchange of numerous messages to balance electricity demand and supply and, most importantly, making sure that remittance information and records are properly conveyed. To ensure efficiency, the network of entities managed by the ISO is best served if the various messages, reports, and datasets can be directly integrated to the appropriate software applications that process this information in each entity. Exemplary embodiments of the present invention can allow the ISO to utilize standard formats for the messages, reports and datasets, while at the same time allowing each entity involved to map these standards to there own internal formats. In addition, exemplary embodiments can allow entities to maintain records of pending and completed transactions, as well as being able to produce archived information that can provide the basis for non-repudiation of a transaction by any of the parties involved in that transaction.

The ISO begins by configuring a transaction administrator 115 to include the definitions of a normative data model for all messages, reports and datasets to be exchanged. The ISO also configures a transaction administrator 115 with administrative information such as the data about the bilateral and multi-lateral agreements between the entities for which it is responsible, the definition of any administrative messages, such as queries of each involved entity's data store to determine the state of transactions, and the like. The ISO then distributes and verifies the installation of one or more transaction exchangers 110 to each entity in its network of responsibility. Along with the installation, the ISO provides in a secure a manner a private key that uniquely identifies each transaction exchanger 110 for each entity. Such a procedure allows the entities to uniquely encrypt and digitally sign messages reports and datasets. The entity can then execute administrative transactions with the ISO that provide, for example, information about which other entities it can exchange messages, definitions of the transaction to be executed, definitions of the content of the messages, reports, datasets to be used in those transactions, and the like. Next, an entity, using the tools provided with the transaction exchanger 110, can integrate messages to the internal applications (i.e., the client application devices 105), specifically by configuring the appropriate transport wrapper and by mapping internal formats to the normative message definitions provided by the ISO.

Messages, reports and datasets can now flow from the client application devices 105 in one entity to the ISO or another allowed entity. Aspects of any messages, reports, and datasets can be encrypted and/or digitally signed to ensure the reliability and security of a transaction. Each entity can have local, protected information of transactions in which it has been involved. The ISO can have access to relevant information from all entities through its administrative queries. The ISO manages a complex, dynamic set of entities and relationships. Changing requirements require message, reports and dataset formats to be modified or created. These changes can be efficiently handled in a non-disruptive and dynamic manner through the administrative message and re-mapping capabilities of the transaction exchanger 110 and transaction administrator 115.

D. Inventory Management

With respect to inventory management, assume that a large manufacturer desires real-time, just-in-time, inventory purchase and supply for all necessary parts from their parts suppliers, based upon actual real-time orders from their dealers and distributors. Such ability optimizes inventory turn ratios, enhances sales through ability to fill orders in a timely manner, and ensures that only the correct pieces and parts are purchased. However, each parts supplier utilizes a different parts-ordering system, with different data types and formats that prohibit on-line interaction. Each of these systems is built using differing technologies, differing data formats, and there is no capacity to receive orders from other computer systems, no capacity to identify part availability or price back to the manufacturer, and no capacity to roll up the collective information into a cohesive, accurate, real-time ability for the manufacturer to purchase parts automatically. Exemplary embodiments of the present invention can allow such disparate parts systems (between the various suppliers, and the manufacturer) to automatically exchange part availability, price, quantity, and other desired information without modification to any of the existing systems (either suppliers' or manufacturer's).

The Solution Provider begins by configuring a transaction exchanger 110 to include the content requirements of each desired parts transaction. The Solution Provider defines the normative data model, data validation rules, security requirements and rules, custom processes, data enrichment processes, routing rules, error handling processes, and other pertinent processes. The Solution Provider then configures a copy of the transaction exchanger 110 to operate at the manufacture's site, whereby each valid parts transaction received from another copy of the transaction exchanger 110 is translated from the normative form into the Manufacturer's desired format for its processing by the Manufacturer's local application.

The Solution Provider then configures a copy of the transaction exchanger 110 at the site of each supplier's system from whom they desire to receive automatic parts transactions. The transaction exchanger 110 is configured to operate with each supplier's local parts application(s) (i.e., the client application devices 105). The transaction exchanger 110 processes transactions from the format used by the supplier's client application device 105 into the format used by the supplier's transaction exchanger 110. Each supplier's version of the transaction exchanger 110 then validates, enriches, secures, records, logs the data according to the processes and/or rules established by the solution provider, returning errors to the supplier's system as configured, and then sends successful parts transaction messages, in normative form, to the manufacturer's system. The transaction messages are received by the transaction exchanger 110 located at the manufacturer, checked against all content and validation rules, then processed from normative form into the format used by the manufacturer's transaction exchanger 110, logged, confirmed and processed into the transaction information used by the manufacturer's local application. Accordingly, automated parts orders can then flow from the transaction exchangers 110 located at each of the supplier sites to the transaction exchanger 110 located at the manufacturer—flowing part transactions from each remote, diverse, supplier application to the manufacturer's application, without modification to the manufacturer's or any of the existing supplier applications.

E. Government

The federal government desires up-to-date visibility and accuracy on all aspects of military-related inventory, including personnel, ordinance, and military logistics, across all divisions of the armed forces, and across all state-controlled divisions of the National Guard. Such information is vital to national defense. However, each armed service utilizes different logistical tracking systems, sometimes multiple systems. Each is built using differing technologies, differing data formats, and there is no capacity to share changes within any singular tracking system with any other tracking system, no capacity to move inventory between one tracking system and any other, and no capacity to roll up the collective information into a cohesive, accurate, real-time status of all forces' inventory, ordinance or other pertinent information. Exemplary embodiments of the present invention can allow such disparate logistics systems (between the various branches of the armed forces, within each force, and with each state National Guard) to automatically exchange information without modification to any of the existing systems.

The Solution Provider begins by configuring a transaction exchanger 110 to include the content requirements of each desired logistical information transaction. The Solution Provider defines the normative data model, data validation rules, security requirements and rules, custom processes, data enrichment processes, routing rules, error handling processes, and other pertinent processes. The Solution Provider then configures a copy of the transaction exchanger 110 to operate at the Federal level, whereby each valid logistic information transaction received from another copy of the transaction exchanger 110 is translated from the normative form into the Federal system's desired format for its processing. The Solution Provider then configures a copy of the transaction exchanger 110 at the site of each logistics system from whom they desire to receive automatic information transactions. The transaction exchanger 110 is configured to operate with each force's local logistic application(s) (i.e., the client application devices 105). The transaction exchanger 110 processes payments in the format used by the client application device 105 into the format used by the force's version of the transaction exchanger 110. Each force's version of the transaction exchanger 110 then validates, enriches, secures, records, logs the data according to the processes and/or rules established by the solution provider, returning errors to the local logistics system as configured, and then sends successful logistical transaction messages, in normative form, to the federal system.

The transaction messages are received by the transaction exchanger 110 located at the federal level, checked against all content and validation rules, then processed from normative form into the format used by the transaction exchanger 110 at the federal level, logged, confirmed and processed into the transaction information used by the federal level local application. Accordingly, automated logistic information transactions can then flow from the transaction exchangers 110 located at each of the armed forces and state National Guard sites to the transaction exchanger 110 located at the federal level—flowing information from each remote, diverse, logistics application to the Federal applications, without modification to the Federal, state-level or any armed forces existing logistics applications.

F. Insurance

Assume that a Service Provider wishes to create a direct network between all participants associated with processing and executing elements of a property insurance claim process. The participants in the property claims process can include insurance agents, claims adjustors, private contractors to bid and execute specific work, inspectors, payment providers, and others. While the collection of potential participants may desire to participate in such a direct network, they must also participate in claims processes outside of that network, as not all industry participants will join the service simultaneously. Therefore, the interested participants may not be willing to accept any requirements from the service provider that forces them to change their current operations, the internal systems that they currently utilize, or use two different processes—one for claims within the network and another for claims outside the network. The Service Provider has specific data requirements and data formats that define such transactions and that encompass the type of activities/transactions received during the process of making, substantiating, and ruling on a claim. The Service Provider also has certain data content, data validation, and other rules that they desire that each transaction conform to (e.g., what information a specific participant can access or cannot access in the transaction, a rule to determine who is qualified to participate in this specific transaction in the claims process, and the like). However, each potential participant has application systems that utilize a different data format or formats. Exemplary embodiments of the present invention can allow such disparate application systems (between all participants of the claims process) to automatically exchange the specific formats or combination of the formats required of successful claims processing, without modification to their applications.

The Service Provider begins by configuring a transaction exchanger 110 to include the content requirements of each desired format of the pertinent transactions. The Service Provider defines the normative data model, data validation rules, security requirements and rules, custom processes, data enrichment processes, routing rules, error handling processes, and other pertinent processes. The Service Provider then configures a copy of the transaction exchanger 110 so that it can receive valid transactions from another copy of the transaction exchanger 110. The Service Provider then configures a copy of the transaction exchanger 110 for each participant with whom they desire to participate in the transactions. The transaction exchanger 110 is configured to operate with each participant's local application(s) (i.e., the client application devices 105). The transaction exchanger 110 processes transactions in the format of that participant's client application device 105 into the format used by that participant's version of the transaction exchanger 110. The participant's version of the transaction exchanger 110 then validates, enriches, secures, records, logs the data according to the processes and/or rules established by the Service Provider as well as rules and processes that the participant themselves can establish, returning errors to the participant as configured, and then sending successful insurance claim transaction messages, in normative form, to another participant. The transaction messages are received by the transaction exchanger 110 located at the other participant's site, checked against all content and validation rules, then processed from normative form into the format used by that participant's transaction exchanger 110, logged, confirmed and processed into the transaction information used by that participant's local application. Accordingly, automated transactions can then flow from the transaction exchangers 110 located at participant sites to the transaction exchangers 110 located at other participant's sites—flowing insurance claim transactions from one participant's application to another participant's applications, without modification.

G. Healthcare

The healthcare industry is currently characterized by a multitude of disparate organizations involved in the care of common patients. The difficulties associated with capturing critical patient data and making it available in a timely fashion is a well-documented problem plaguing the industry, often resulting in sub-par patient care, and always resulting in excessive cost. Antiquated and disparate legacy systems within hospitals, physicians' offices, laboratories, pharmacies and insurance companies, combined with patient confidentiality and privacy regulations, are at the root of a data sharing challenge that has significantly restricted the industry. Exemplary embodiments of the present invention can be used within the healthcare industry to address many aspects as such problems within the industry. Large, decentralized organizations (like health systems with affiliated hospitals, physician practices, laboratories, pharmacies, and the like) can be linked to exchange information between them, efficiently and accurately, without consolidating sensitive data into a single database. Individual service providers, who have varying degrees of computer application ability, can link into much larger networks of affiliates, without significant cost or confusion. Within health systems, the present invention can enable data to flow between disparate applications without requiring the significant outlay of financial resources and time necessary to align extremely large legacy applications, such as medical records, enrollment, scheduling, pharmacy, laboratory, and billing. As a result, consistent information can be made available to all medical professionals in a timely fashion, thereby contributing to the overall quality of care and customer service.

The Service Provider begins by configuring a transaction exchanger 110 to include the content requirements of each desired format of the pertinent transactions. The Solution Provider defines the content requirements of each desired healthcare transaction (e.g., an update to a medical record, a prescription, or an order for a medical test, and the like). The Solution Provider then defines the normative data model, data validation rules, security requirements and rules, custom processes, data enrichment processes, routing rules, error handling processes, and other pertinent processes to perform against the data being transferred. A copy of the transaction exchanger 110 is then configured for each independent health care organization, whereby each valid transaction received from another copy of the transaction exchanger 110 is translated from the normative form into the format used by that organization's transaction exchanger 110 to generate the transaction information in the format used by that organization's local applications. Using such a model, the originator of the data is able to push the content to all interested parties with no incremental effort, and the overall access to medical information is vastly improved. At no time is sensitive patient data exposed beyond those entities that require the information.

Another significant challenge facing the health industry today is the expense and difficulty in servicing the process of HMO claims. Healthcare administration costs currently run at 25% or more of revenue, as compared to less than 5% in the financial industry. Such a disparity is due to the complexity of the healthcare industry, coupled with the healthcare industry's lack of automated processing capabilities. HMO plans are riddled with industry rules and requirements that the member and the health care providers must adhere to in order to receive benefit payments from the insurance companies. For example, referrals and pre-authorizations are typically required for services delivered by a provider other than the member's PCP, or out of the member's home service area. Getting the right information to the various parties involved (providers, labs, pharmacies, and insurers) is today generally done by telephone or fax, often leading to errors, as the right information is not always provided in the right format. Time delays often result, both in receiving the service and paying claims for the service. The information is passed via telephone, because the providers' current data systems are different from the insurer's, and will not integrate easily. Another example of the inefficiency that this causes is that the information a PCP may communicate to a pharmacy or lab may not always be the full data the pharmacy or lab may require. Furthermore, claims submitted to an insurer, even electronically submitted claims, may have data issues, such as, for example, missing or incomplete data, that require human intervention to fix. Using exemplary embodiments of the present invention, the providers, insurers, labs, pharmacies can automatically communicate with each other in automated, interactive fashion. The industry has already defined standards for several health claim transactions, such as referrals and authorizations. As further agreed standards are accepted, the last hurdles will be the ease of integration, which the present invention directly addresses.

A Solution Provider can begin by configuring a transaction exchanger 110 to include the content requirements of each desired claims transaction. The Solution Provider defines the normative data model, data validation rules, security requirements and rules, custom processes, data enrichment processes, routing rules, error handling processes, and other pertinent processes. The Solution Provider then configures a copy of the transaction exchanger 110 to operate at the Insurer level, whereby each valid claims transaction received from another copy of the transaction exchanger 110 can be translated from the normative form into Insurer's desired format for processing the claims transaction.

The Solution Provider then configures a copy of the transaction exchanger 110 at the site of each participating provider system from whom they desire to receive automatic claims transactions. The transaction exchanger 110 is configured to operate with each provider's local application(s) (i.e., the client application devices 105). The transaction exchanger 110 processes claims from the format used by the provider's client application device 105 into the format used by the provider's version of the transaction exchanger 110. Each provider's version of the transaction exchanger 110 then validates, enriches, secures, records, logs the data according to the processes and/or rules established by the solution provider, returning errors to the local claims system as configured, and then sending successful claims transaction messages, in normative form, to the Insurer's system. The transaction messages are received by the transaction exchanger 110 located at the Insurer level, checked against all content and validation rules, then processed from normative form into the format used by the Insurer's transaction exchanger 110, logged, confirmed and processed into the transaction information used by the Insurer's local applications. Multiple insurers can implement the Insurer's version of the transaction exchanger 110. Each provider that utilized a version of the transaction exchanger 110 can provide automatic claims to any Insurer that utilized an Insurer's version of the transaction exchanger 110. Over time, a fully integrated transaction network can grow that is capable of processing accurate claims without modifying any of the local applications, saving the industry significant time and money, while improving accuracy.

H. Pharmaceuticals

In the pharmaceutical industry, every new drug can take up to 15 years and over 275 million dollars in clinical costs before the FDA approves the drug. A primary reason for the excessive time and the cost is the enormous problem of consolidation and analysis of clinical trial data. Each pharmaceutical company literally maintains warehouses of paper-based clinical trial data. It can take years for such data to be assembled, consolidated, analyzed, and conclusions drawn. In addition to time and cost, patients wait or even die. Assembling clinical trial data is problematic, because all of the pertinent participants (pharmaceutical companies, hospitals, clinics, doctors, pharmacies, and the like) utilize disparate data systems. The industry's answer to date for such a problem has been to use paper to record data—paper that is then sent to warehouses where it waits to be manually entered into a consolidated system. Exemplary embodiments of the present invention in the pharmaceutical industry can allow such disparate application systems (hospitals, clinics, doctors, pharmacies, and the like) to automatically send pertinent clinical trial data to the pharmaceutical company, without modification to any of their existing applications, and without the use of paper. The present invention can allow a pharmaceutical company to determine the requirements of the information that must be captured for a successful clinical trial (i.e., patient history, age, weight, symptoms, and the like). The pharmaceutical company then defines the types of transactions (e.g., routine data update, emergency data update, adverse events notification, and the like). The pharmaceutical company also defines data content, data validation, and other rules that they require each trial record to conform to (e.g., how patient anonymity is protected at all times during the clinical trail, while important drug information is captured and sent on, and the like).

The pharmaceutical company begins by configuring a transaction exchanger 110 to include the content and processing requirements of each desired clinical trial transaction. The pharmaceutical company then defines the normative data model, data validation rules, security requirements and rules, custom processes, data enrichment processes, routing rules, error handling processes, administrative messages and rules, and other pertinent processes. The pharmaceutical company then configures a local copy of the transaction exchanger 110 so that the transaction exchanger 110 can receive valid clinical updates from any other copy of the transaction exchanger 110, and so that any clinical updates that are received are processed into the format required by existing analysis applications within the pharmaceutical company, or to a new application.

The pharmaceutical company then configures a copy of the transaction exchanger 110 at the site of each doctor, hospital, or clinic with whom they desire to be participants in the closed clinical trail. Each transaction exchanger 110 is configured to operate with that particular health care provider's application(s) (i.e., the client application devices 105). The transaction exchanger 110 is also configured to interact with the pharmaceutical company's transaction exchanger 110, passing to it normative versions of the clinical data transactions. Each transaction exchanger 110 processes transaction information from that health care provider's client application device 105 into the format used by that health care provider's version of the transaction exchanger 110. The health care provider's version of the transaction exchanger 110 then validates, enriches, secures, records, logs the data according to the processes and/or rules established by the pharmaceutical company, as well as rules and processes that the health care provider's themselves can establish (e.g., local logging of their patients' data that was sent on to the pharmaceutical company), returning errors to the health care provider as configured, and then sending successful healthcare transaction messages, in normative form, to the pharmaceutical company. The transaction messages are received by the transaction exchanger 110 located at the pharmaceutical company site, checked against all content and validation rules, then processed from normative form into the format used by the pharmaceutical company's transaction exchanger 110, logged, confirmed and processed into the transaction information used by the pharmaceutical company's local applications. Accordingly, automated clinical trial data can then flow from the transaction exchangers 110 located at each health care provider's site to the transaction exchangers 110 located at the pharmaceutical company's site—flowing healthcare data from each health care provider's application to the pharmaceutical company's applications without modification, saving time, cost, and even lives.

I. Ticket Issuing/Payment Systems

Assume that the Ticket Issuing and/or Payment Systems division within a ticket issuer wishes to receive automatic ticket issuing and/or payment transactions from their corporate customers. The ticket issuer has a specific back-end application format that they desire for all transactions received. The ticket issuer also has certain data content, data validation, and other rules that they desire that each automatic transaction conform to. Each customer has application systems that utilize a format or formats different than that desired by the ticket issuer. Exemplary embodiments of the present invention can allow such disparate application systems (between the ticket issuer and the ticket issuer's customers) to automatically exchange ticket issuing and/or payments without modification to either the ticket issuer's or the customers' applications.

The ticket issuer begins by configuring a transaction exchanger 110 to include the content requirements of each desired ticket issuing and/or payment transaction. The ticket issuer defines the normative data model, data validation rules, security requirements and rules, custom processes, data enrichment processes, routing rules, error handling processes, and other pertinent processes. The ticket issuer then configures a copy of the transaction exchanger 110 to operate within the ticket issuer, whereby each valid transaction received from another copy of the transaction exchanger 110 is translated from the normative form into the ticket issuer's desired format for its back-office processing.

The ticket issuer then configures a copy of the transaction exchanger 110 at the site of each corporate customer from whom they desire to receive automatic ticket issuing and/or payment transactions. The transaction exchanger 110 is configured to operate with each customer's local application(s) (i.e., the client application devices 105). The transaction exchanger 110 processes ticket issuing and/or payments from the format used by that customer's client application device 105 into the format used by the customer's version of the transaction exchanger 110. The customer's version of the transaction exchanger 110 then validates, enriches, secures, records, logs the data according to the processes and/or rules established by the ticket issuer, returning errors to the customer as configured, and then sending successful ticket issuing and/or payment transaction messages, in normative form, to the ticket issuer. The transaction messages are received by the transaction exchanger 110 located at the ticket issuer, checked against all content and validation rules, then processed from normative form into the format used by the ticket issuer's transaction exchanger 110, logged, confirmed and processed into the transaction information used by the ticket issuer's back-office application. Accordingly, automated ticket issuing and/or payment transactions can then flow from the transaction exchangers 110 located at customer sites to the transaction exchanger 110 located at the ticket issuer site—flowing ticket issuing and/or payments from customer applications to the ticket issuer's back-end applications, without modification to either the ticket issuer's or the customers' applications.

J. Sarbanes-Oxley (SOX) Compliance

Assume that the SOX Verification and/or Financial Systems division within a corporation wishes to receive automatic verification and/or financial transactions from their corporate operating units. The corporation has a specific back-end application format that they desire for all transactions received. They also have certain data content, data validation, and other rules to which they desire that each automatic transaction conform. Each corporate operating unit has application systems that utilize a format or formats different than that desired by the corporation. Exemplary embodiments of the present invention can allow such disparate application systems (between the corporation and the corporation's operating units) to automatically exchange verification and/or financials without modification to either the corporation's or the corporate operating units' applications.

The corporation begins by configuring a transaction exchanger 110 to include the content requirements of each desired verification and/or financial transaction. The corporation defines the normative data model, data validation rules, security requirements and rules, custom processes, data enrichment processes, routing rules, error handling processes, and other pertinent processes. The corporation then configures a copy of the transaction exchanger 110 to operate within the corporation, whereby each valid transaction received from another copy of the transaction exchanger 110 is translated from the normative form into the corporation's desired format for its back-office processing. The corporation then configures a copy of the transaction exchanger 110 at the site of each corporate operating unit from whom they desire to receive automatic verification and/or financial transactions. The transaction exchanger 110 is configured to operate with each corporate operating unit's local application(s) (i.e., the client application devices 105). The transaction exchanger 110 processes verification and/or financials from the format used by that corporate operating unit's client application device 105 into the format used by the corporate operating unit's version of the transaction exchanger 105. The corporate operating unit's version of the transaction exchanger 110 then validates, enriches, secures, records, logs the data according to the processes and/or rules established by the corporation, returning errors to the corporate operating unit as configured, and then sending successful verification and/or financial transaction messages, in normative form, to the corporation. The transaction messages are received by the transaction exchanger 110 located at the corporation, checked against all content and validation rules, then processed from normative form into the format used by the corporation's transaction exchanger 110, logged, confirmed and processed into the transaction information used by the corporation's back-office application. Accordingly, automated verification and/or financial transactions can then flow from the transaction exchangers 110 located at corporate operating unit sites to the transaction exchanger 110 located at the corporation site—flowing verification and/or financials from corporate operating unit applications to the corporation's back-end applications, without modification to either the corporation's or the corporate operating units' applications.

K. Communications

Assume that the Communication Payload Instructions and/or Payment Systems division within a communications company wishes to receive automatic communications payload instructions (e.g., payloads can include, for example, voice, data, video, MP3 and optical formats and the like) and/or payment transactions from their corporate customers. The communications company has a specific back-end application format that they desire for all transactions received. They also have certain data content, data validation, and other rules that they desire that each automatic transaction conform to. Each customer has application systems that utilize a format or formats different than that desired by the communications company. Exemplary embodiments of the present invention can allow such disparate application systems (between the communications company and the communications company's customers) to automatically exchange communications payload instructions and/or payments without modification to either the communications company's or the customers' applications.

The communications company begins by configuring a transaction exchanger 110 to include the content requirements of each desired communications payload instructions and/or payment transaction. The communications company defines the normative data model, data validation rules, security requirements and rules, custom processes, data enrichment processes, routing rules, error handling processes, and other pertinent processes. The communications company then configures a copy of the transaction exchanger 110 to operate within the communications company, whereby each valid transaction received from another copy of the transaction exchanger 110 is translated from the normative form into the communications company's desired format for its back-office processing.

The communications company then configures a copy of the transaction exchanger 110 at the site of each corporate customer from whom they desire to receive automatic communications payload instructions and/or payment transactions. The transaction exchanger 110 is configured to operate with each customer's local application(s) (i.e., the client application devices 105). The transaction exchanger 110 processes communications payload instructions and/or payments from the format used by that customer's client application device 105 into the format used by the customer's version of the transaction exchanger 110. The customer's version of the transaction exchanger 110 then validates, enriches, secures, records, logs the data according to the processes and/or rules established by the communications company, returning errors to the customer as configured, and then sending successful communications payload instructions and/or payment transaction messages, in normative form, to the communications company. The transaction messages are received by the transaction exchanger 110 located at the communications company, checked against all content and validation rules, then processed from normative form into the format used by the communications company's transaction exchanger 110, logged, confirmed and processed into the transaction information used by the communications company's back-office application. Accordingly, automated communications payload instructions and/or payment transactions can then flow from the transaction exchangers 110 at customer sites to the transaction exchanger 11—at the communications company site—flowing communications payload instructions and/or payments from customer applications to the communications company's back-end applications, without modification to either the communications company's or the customers' applications.

There are many other examples of uses and applications of exemplary embodiments of the present invention to other types of transaction for other types of industries.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

One embodiment of exchanging transaction information in an automated manner includes automatically processing faxes or other similar image information. The following thirteen slides included herein provide details of a fax processing application that automates transaction oriented faxes. That is, the party that receives transaction information is a fax can process the faxes using the features that are described in the included slides.

In another embodiment, the incoming digital data (for example, fax or image data) can also be associated with digital signatures or human signatures that are available in machine readable form. A human signature is available in a machine readable form, i.e., a jpeg (as an example of a machine readable image format). The signature is signed using any type of digital signature mechanism as would be recognized by those skilled in the art (for example, by use of PGP or PKI using a 509 certificate). The digital signing can optionally include a date and a time. The resulting digitally signed signature cannot be tampered with. The digitally signed signature can then be bound to any machine readable data set. As used herein, a data set is meant to be any type of information persisted in any form of computer or electronic or optical storage, e.g., a memory, a data file, part a record in a database). That is, a digital signature is created using a digital signature mechanism to sign both the signed human signature and the machine readable record. This binding digital signature can optionally include a date and time. The digitally signed human signature and the data record are then associated in a manner that is both non-refutable and tamperproof.

In a variation of the above discussed digitally signed human signature, the binding signature includes an indirect reference to the signed human signature so that the machine readable data set need not be physically stored contiguously.

In another a variation of the above discussed digitally signed human signature, the binding signature binds a digitally human signature human signature with a message, e.g., an EDI message like those defined by SWIFT's FIN messages (ISO 7775, ISO 15022), Healthcare's HL7 messages, B2B commerce RosettaNet messages, etc.

In another variation, the machine readable human signature is extracted from a larger image, for example, from the TIFF file or a JPEG file. In a further variation, the machine readable human signature is produced from an OCR program that is reading an image file, for example, the TIFF file created when a fax is received and electronically stored.

What is claimed is:

1. A computer implemented method of processing a received facsimile image, comprising the steps of:
processing the received facsimile image to identify text data in the facsimile image;
converting the identified text data to a standardized format;
validating the identified text data in the standardized format; and
mapping the text data in the standardized format to data in a specified format; and
providing the data in the specified format for further processing.

2. The method according to claim 1, wherein the processing step comprises performing optical character recognition of the received facsimile image.

3. The method according to claim 1, wherein the optical character recognition is configured to identify specific fields in the text data with different thresholds of accuracy for some of the specific fields.

3. The method according to claim 1, wherein the converting step comprises converting the identified text data into a well formed XML format.

4. The method according to claim 1, wherein the validating step comprises applying business rules based on a type of a transaction identified from the text data.

5. The method according to claim 4, wherein the business rules include processing rules on a fund manager basis.

6. The method according to claim 3, wherein the step of mapping the text data comprises mapping the XML format data to create a transaction conforming to a SWIFT format.

7. The method according to claim 1, further comprising an error processing step for processing any errors identified in any of the processing, converting, validating, or mapping steps.

8. The method according to claim 1, wherein the step of mapping the text data in the standardized format to data in the specified format comprises validating the data in the specified format against the requirements of the specified format.

9. The method according to claim 1, wherein the step of providing the data in the specified format for further processing comprises using a proprietary internal system to process data in the specified format.

10. A system for processing a facsimile image, comprising:
a communication module that receives a facsimile image; and
one or more transaction processors configured to
process the received facsimile image to identify text data in the facsimile image,
convert the identified text data to a standardized format,
validate the identified text data in the standardized format,
mapping the text data in the standardized format to data in a specified format, and
providing the data in the specified format for further processing.

11. A computer readable medium having program code recorded thereon that, when executed on a computing system, processes a facsimile image, the program code comprising:
code for processing the received facsimile image to identify text data in the facsimile image;
code for converting the identified text data to a standardized format;
code for validating the identified text data in the standardized format; and
code for mapping the text data in the standardized format to data in a specified format; and
code for providing the data in the specified format for further processing.

12. The method according to claim 1, further comprising associating a digital signature with the received facsimile image.
